(19) United States
(12) Patent Application Publication
(10) Pub. No.: US 2016/0334312 A1
(43) Pub. Date: Nov. 17, 2016

(54) PRE-CONCERTATION APPARATUS & METHOD

(71) Applicants: Angelo Gaitas, Miami, FL (US); Gwangseong Kim, Miami, FL (US)

(72) Inventors: Angelo Gaitas, Miami, FL (US); Gwangseong Kim, Miami, FL (US)

(73) Assignee: Angelo Gaitas, Miami, FL (US)

(21) Appl. No.: 15/222,590

(22) Filed: Jul. 28, 2016

Related U.S. Application Data
(63) Continuation-in-part of application No. 14/936,112, filed on Nov. 9, 2015.
Application No. 14/936,112 is a continuation-in-part of application No. 14/567,784, filed on Dec. 11, 2014, now abandoned.
Application No. 14/567,784 is a continuation-in-part of application No. 14/564,042, filed on Dec. 8, 2014.
Application No. 14/564,042 is a continuation-in-part of application No. 14/482,270, filed on Sep. 10, 2014.
(60) Provisional application No. 61/900,070, filed on Nov. 5, 2013.

(51) Int. Cl. G01N 1/40; B01L 3/00

(52) U.S. Cl. CPC G01N 1/405; B01L 3/502761; B01L 3/502715; B01L 3/50273; B01L 2300/0877; B01L 2200/0631

(57) ABSTRACT

The present invention relates to concentrating disease causing agents, such as foodborne pathogens, from complex media to expedite their detection. In particular, the present invention relates to a method to pre-concentrate pathogens rapidly, thereby enabling earlier detection times. Primarily, the present invention utilizes an approach that can concentrate the pathogens by flowing a sample through immuno-capturing tubes (“entrapment chamber” or “chamber”) during an early pre-enrichment period. Also, the invention relates to using binding materials to trap disease causing agent that is desired to be removed from the complex media such as the blood of a patient. It also related to using lights of specific wavelength to inactivate pathogens. The light is used to activate reactive oxygen species using a photo-sensitizer or directly kill the pathogen using light of wavelength between 100 nm and 450 nm.

### CROSS REFERENCE TO RELATED APPLICATIONS

This application is a continuation-in-part of U.S. Non-Provisional Utility patent application Ser. No. 14/936,112 filed Nov. 9, 2015, and entitled “Blood Cleansing Apparatus and Method, which is a continuation-in-part of U.S. Non-Provisional Utility patent application Ser. No. 14/567,784 filed Dec. 11, 2014, and entitled “Blood Cleansing System & Method”, which is a continuation-in-part of U.S. Non-Provisional Utility patent application Ser. No. 14/564,042 filed Dec. 8, 2014, and entitled “Blood Cleansing System”, which is a continuation-in-part of U.S. Non-Provisional Utility patent application Ser. No. 14/482,270 filed Sep. 10, 2014, and entitled “Blood Cleansing System”, each of which claims the benefit of U.S. Provisional Patent Application No. 61/900,070 filed Nov. 5, 2013 and entitled “Blood Cleansing System,” the entire disclosures of each and all of the above mentioned references are hereby incorporated herein by reference.

### GOVERNMENT SUPPORT

This invention was made with government support under U.S. Public Health Service Grant No. GM084520 from the National Institutes of Health. The Government has certain rights in the invention.

### FIELD OF THE INVENTION

The present invention relates to concentrating and pre-concentrating disease causing agents from a fluid sample. Specifically, the invention relates to using binding materials to trap disease causing agents for further analysis.

### BACKGROUND OF THE INVENTION

Many diseases, as well as other harmful particles and biological molecules, are carried by the blood, food, urine, body fluids, and consumed liquids. Currently, a major bottle neck in pathogen detection is the time it takes to detect pathogens because standard methods for pathogen testing are based on selective culturing, requiring multiple incubation steps, each step usually taking 18-24 hours. Even state-of-art detection methods such as polymerase chain reaction (PCR) and enzyme linked immunosorbent assay (ELISA) require a 18-24 hours of pre-enrichment to reach sufficient quantity of pathogens for detection, given that those methods require a minimum detectable quantity (limit of detection (LOD)) in the order of 10⁴ CFU/mL.

Current foodborne pathogen detection technologies fall into two major categories: culture dependent methods and culture independent methods. The widely used culture dependent methods are relatively simple, accurate and inexpensive. These methods require a series of culturing steps in media favoring the growth of target pathogens while suppressing the growth of other organisms. However, because of the reliance on multiple sub-cultures (usually 18-24 hours for each step), these methods are consuming and therefore limited when it comes to time critical situations, such as foodborne illness outbreaks. Culture independent detection methods were developed to address these specific needs for rapid detection. These include molecular technologies (PCR, iso-thermal, etc.) and immunological technologies (such as ELISA). Although these methods do not require serial culturing steps, they require a minimum detectable quantity (1000 CFU/mL for PCR and 10000 CFU/mL for ELISA). Therefore, present culture independent detection methods still require an initial pre-enrichment step to obtain sufficient concentration of pathogens, process that takes 18-24 hours. Most research efforts are focused on improving the sensitivity of detection mechanisms. Despite considerable advances, detection of very low number of pathogens is an unresolved challenge.

One technology used for food pathogen detection is a serial selective culturing technique, as outlined in the FDA Bacteriological Analytical Manual (BAM). That process entails culture based methods with culture independent detection technologies (PCR, lateral flow device, ELI SA etc.) (USDA Microbiology Laboratory Guide-books). Culture media and established detection technologies are the primary competing technologies. The inefficiency of these methods is the well-recognized drawback as outlined above. The majority of the research and development efforts in the marketplace have focused on lowering the detection limit (LOD) of detection technologies. However, less work has been done on reducing enrichment times. Despite significant advances, current state-of-art technology still requires a concentration of at least 1000 CFU/mL, which, with current enrichment and concentration technology, still requires 18-24 hours of pre-enrichment.

A recently reported commercially available competing technology relies on filtration based concentration (Innova Prep concentrating pipette). This technology is limited to simple conditions, so it would not work for complex samples, such as ground beef testing. Also, it is not target specific and requires additional steps to enrich and isolate targeted pathogens.

Immunomagnetic separation methods have been employed in certain pathogen testing protocols following a 24 hour pre-enrichment, but not for reducing the required time for pre-enrichment. However, immunomagnetic separation still requires some level of pathogen pre-enrichment and is limited to one target organism per sample.

Another method employs bacteriophage for listeria detection within 6 hours. This technology is based on labeling target bacteria using bacteriophage. The technology requires first 6 hours for bacterial growth, and then requires centrifugation to concentrate the labeled pathogens that are inserted into another machine for visualization.

Therefore, there is a need in the art for a system and method to reduce the time required to reach the detection limits, including the simultaneous pre-concentration of various pathogens in one sample. These and other features and advantages of the present invention will be explained and will become obvious to one skilled in the art through the summary of the invention that follows.

### SUMMARY OF THE INVENTION

Accordingly, it is an object of the present invention to provide a method for concentrating disease causing agent from a fluid sample. In particular, this invention discloses a method and an apparatus to concentrate disease causing agents for faster analysis. According to an embodiment of the present invention, the target material is one or more target material selected from a group of target material comprising cancer stem cells, metastatic cancer cells, cancer cells, circulating tumor cells, viruses, microorganisms, bacteria, peptides, beta amyloid (Amyloid beta, Aβ, Abeta), proteins, enzymes, toxins, diseased cells, infectious microorganisms, cells, fungi, pathogens, materials, Carbapenem-resistant Enterobacteriacea, CRE bacteria, Ebola, Malaria, cholesterol, glucose, parasitic protozoans, Klebsiella pneumoniae Carbapenemase (KPC)-Producing Bacteria, Alzheimer's causing material, diseased cells, sepsis causing organisms, lactate, other material that is desired to be removed from blood, disease causing agents, stem cell-like cancer cells, microbial organisms, biomolecules, HIV virus, Methicillin-resistant Staphylococcus aureus, septic shock and sepsis infections causing microorganisms, bacteremia, toxic materials, mesenchymal tumor cells, cholesterol, CTCs, disease causing agents, herpes, herpes viruses, Gram-positive bacteria, Gram-negative bacteria, parasites, cytokines, food pathogens, pathogen byproducts, and reporters of disease causing agents. According to an embodiment of the present invention, a fluid sample is one or more fluid samples selected from a group of fluid samples comprising: media, body fluids, cerebrospinal fluid, complex media, broth, blood, culture media, urine, water, swabs, the blood of a patient, broths, culture media, food samples, blood derivatives, sputum, or any fluid containing pathogens or agents. In many cases food samples are placed in a broth or culture media so that pathogens can grow for detection. In this disclosure “complex media” and “sample fluid” and “fluid” are used interchangeably.

According to an embodiment of the present invention, a fluid sample is pumped and flows through an entrapment chamber (or just chamber) that contains one or more of the following: a entrapment chamber with pillars (or micropillars), micro-posts, tube or tubes, well(s) with a microfluidic reaction entrapment chamber (made of a spiraling microfluidic tube), microspheres (beads or microbeads) or spheres, or any combination thereof. Additionally, binding materials may be pre-coated on the entrapment chamber or on parts of the chamber. In a preferred embodiment, as fluid, such as blood flows, through the chamber, targeted substances are trapped while the rest are re-circulated. The process can be repeated several times. In some embodiments, the trapped substances are further analyzed to examine and study disease progression.

According to an embodiment of the present invention, a method for concentrating target material from complex media includes the steps of: pumping complex media into an entrapment chamber; flowing said the solution through said chamber to expose said the solution to a binding material; capturing target material, wherein said binding material targets and binds to said target material; removing said target material from said complex media; and returning said complex media to said sample reservoir. The process is repeated until the quantity of target material in the chamber is enough for detection.

According to an embodiment of the present invention, the binding material is one or more binding materials selected from a group of binding materials comprising antibody, pathogen-capture proteins, opsonin, FcMBL, polymers, synthetic polymers, peptides, proteins, aptamers, nucleic acid, RNA, DNA, organic materials, magnetic particles, TNF-related apoptosis-inducing ligands (TRAIL), ligands, adhesion receptors, E-selectin, cytokines, biological binders, amoxicillin, molecules that adhere to penicillin binding proteins, molecules that adhere to alpha-gal, clavulanic acid, microorganism killing compounds, molecules such as antibodies and peptides that target microorganism's cell walls, molecules that target FtsZ protein, synthetic antibacterials, PC190723, molecules that inhibit FtsZ, adhesion receptors, malarial protein VAR2CSA, rVAR2-diphtheria toxin fusion, rVAR2-hemiasterlin conjugate, rVAR2, Nilotinib, Paclitaxel, E-selectin, and cytokines. One of ordinary skill in the art would appreciate there are numerous binding materials that might be used and embodiments of the present invention are contemplated for use with any such binding material. In some cases, the binding material is also referred to as coating material or simply coating, in this disclosure “antibody” is used as an example, however this particular binding material can be replaced with any other binding material or agent in the chamber.

In another embodiment, this method is applied to conditions requiring blood analysis, including, but not limited to, sepsis, skin infections, cancers, cancer cell, poisoning, leukemia, bacteremia, blood infections, and cholesterol. The method may be performed directly on a patient or indirectly by extracting a sample and analyzing it. In another embodiment, the apparatus is used to isolate and enrich sample fluids such as samples that contain food borne pathogens or urine pathogens or other body fluids. These pathogens include salmonella, e-coli 0157:H7, listeria or other pathogens found in food such as meat, chicken, water, and milk. According to an embodiment of the present invention, the method includes the step of analyzing said disease causing agent that has been captured by said binding material.

According to an embodiment of the present invention, the method further includes the step of counting the amount of said disease causing agent trapped in said entrapment chamber.

According to an embodiment of the present invention, the chamber is comprised of an inlet, an outlet, and a mechanism for removing said disease causing agent.

According to an embodiment of the present invention, an inner surface of said entrapment chamber is coated with said binding material.

According to an embodiment of the present invention, the mechanism is comprised of a plurality of spheres, each of which has an outer surface that is coated with said binding material.

According to an embodiment of the present invention, the mechanism is comprised of a plurality of pillars, each of which is coated with said binding material.

According to an embodiment of the present invention, the mechanism is comprised or one or more tubes, each of which has an inner surface that is coated with said binding material. According to an embodiment of the present invention, the tubes are arranged in series such that each tube is coated with a different binding material specific to the target material.

According to an embodiment of the present invention, the mechanism is further comprised of a nanorough surface. According to an embodiment of the present invention, the mechanism is further comprised of a microrough surface.

According to embodiments of the current method, the entrapment chamber is selected from a group of materials comprising PDMS, organic material, glass, quartz, plastic, polymer, metallic and silicone chambers, Polydimethylsiloxane, polymeric organosilicon compounds, silicone, organic polymer, organic compound, and moldable polymers. Plastics include, but are not limited to, the following materials: Polyester (PES), Polyethylene terephthalate (PET), Polyethylene (PE), High-density polyethylene (HDPE) Polyvinyl chloride (PVC), Polyvinylidene chloride (PVDC) (Saran), Low-density polyethylene (LDPE), Polypropylene (PP), High impact polystyrene (HIPS), Polyamides (PA) (Nylons), Acrylonitrile butadiene styrene (ABS), Polyethylene/Acrylonitrile Butadiene Styrene (PE/ABS), Polycarbonate (PC), Polycarbonate/Acrylonitrile Butadiene Styrene (PC/ABS), Polyurethanes (PU), Maleimide/bismaleimide, Melamine formaldehyde (MF), Plastarch material, Phenolics (PF) or (phenol formaldehydes), Polyepoxide (epoxy), Polyetheretherketone (PEEK), Polyetherimide (PEI) (Ultem), Polyimide, Polylactic acid (PLA), Polymethyl methacrylate (PMMA) (acrylic), Polytetrafluoroethylene (PTFE), Urea-formaldehyde (UF), Furan, Silicone, and Polysulfone. PDMS is a silicon-based organic polymer. Silicon-based organic polymers are plastics.

According to embodiments of the claimed method, the entrapment chamber is an extracorporeal transparent tube with inner diameter is selected from a group of inner diameters of 1.02 mm, 0.64 mm, 0.32 mm, 0.5 mm, 1 mm, 0.8 mm, 2 mm, 3 mm, 6 mm. According to another embodiment of the claimed method, the extracorporeal transparent tube has an inner diameter of less than 2 mm.

According to other embodiments the entrapment chamber is modified with one or more additional binding materials to capture said disease causing agent. According to another embodiment of the claimed method, a series of chambers are used joined to each other, each chamber containing a different binding material to capture disease causing agents.

According to embodiments of the claimed method, the binding material can be one or more of antibodies, protein, peptide, or one or more materials that bind to a disease causing agent. A binding material is a substance that binds to the disease causing agent or to a reporter of the agent or to a byproduct of the agent.

According to embodiments of the claimed method, the conjugate material is used as an imaging agent.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is an illustration of a patient's blood being pumped and flown through the entrapment chamber, after which the blood is injected/circulated back into the patient, in accordance with an embodiment of the present invention.

FIG. 2 is an illustration of a patient's blood being pumped and flown through the chamber, after which the blood is injected back into the patient, in accordance with an embodiment of the present invention.

FIG. 3 is an illustration a pressure monitor, an anticoagulant (such as heparin) pump, and an inflow pressure monitor, in accordance with an embodiment of the present invention.

FIG. 4 is an illustration of a+ solution flowing through a tube to a chamber with spheres that include a binding material, in accordance with an embodiment of the present invention.

FIG. 5 is an illustration of an entrapment chamber including pillars coated with binding material, in accordance with an embodiment of the present invention.

FIG. 6 is an illustration of a chamber composed of tube(s) coated with binding material, in accordance with an embodiment of the present invention.

FIG. 7 is an illustration of a chamber that uses filtering to separate wanted from unwanted material in the complex media or fluid, in accordance with an embodiment of the present invention.

FIG. 8 is an illustration of a tube with captured material for concentration, in accordance with an embodiment of the present invention.

FIG. 9 is an illustration of a light or radiation exposure unit included on the chamber to achieve photochemotherapy or radiotherapy, in accordance with an embodiment of the present invention.

FIG. 10 shows the steps of a tube coating process, in accordance with an embodiment of the present invention.

FIG. 11 shows the steps of a tube coating process, in accordance with an embodiment of the present invention.

FIG. 12 contains pictures of actual tubes with fluorescently labeled captured cells, in accordance with an embodiment of the present invention.

FIG. 13 shows the steps of a tube coating process, in accordance with an embodiment of the present invention.

FIG. 14 shows a schematic of the method of the claimed invention, in accordance with an embodiment of the present invention.

FIG. 15 shows a conceptual diagram of chamber wherein the complex media is circulated through the tube with peristaltic pumping, in accordance with an embodiment of the present invention.

FIG. 16 shows a conceptual diagram of capturing via an antibody immobilized on tube wall, in accordance with an embodiment of the present invention.

FIG. 17 is a diagram of the various components of the apparatus, in accordance with an embodiment of the present invention.

FIG. 18 shows illustrative chamber designs, in accordance with an embodiment of the present invention.

FIG. 19 shows illustrative chamber designs, in accordance with an embodiment of the present invention.

FIG. 20 illustrates various tube connectors and tubes as examples of chambers, in accordance with an embodiment of the present invention.

FIG. 21 illustrates the apparatus disclosed as a dialysis-like apparatus or part of a dialysis machine, in accordance with an embodiment of the present invention.

FIG. 22 illustrates an apparatus for pathogen concentration, in accordance with an embodiment of the present invention.

FIG. 23 illustrates how an embodiment of the disclosed apparatus and method compares to conventional techniques and methods for multiple pathogen capturing.

FIG. 24 illustrates methods for detection, in accordance with an embodiment of the present invention.

### DETAILED SPECIFICATION

The present invention relates to capturing disease causing agents from various biological media including food, water, blood, urine, etc. for concentration. Specifically, the invention relates to using binding materials to trap disease causing agents that are desired to be concentrated (removed from sample) for further analysis.

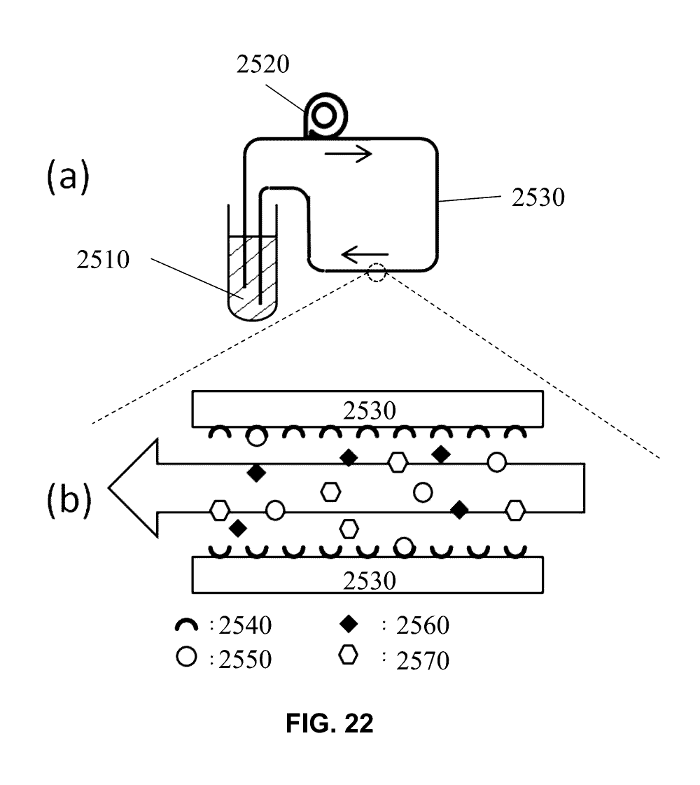

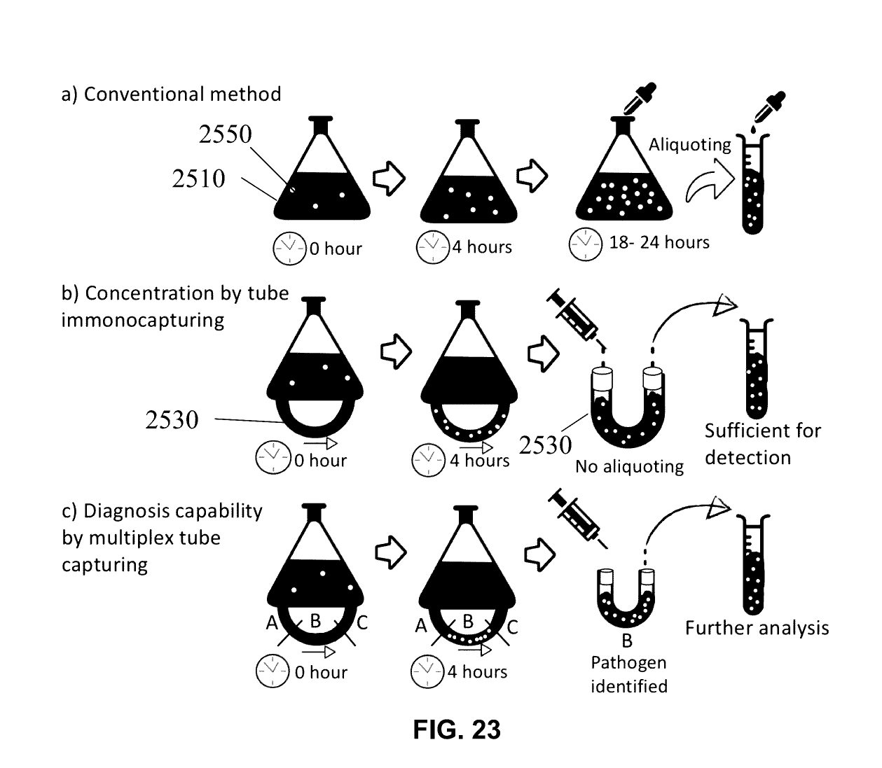

The main feature of the present invention is an antibody conjugated polymer tube. The media containing pathogens is continuously pumped through the coated tube. As the media is flowed through the tube, the pathogens are captured by antibodies inside the tube. This capture and subsequent continuous flow of sample matrix promotes organism concentration within the tube, as organisms divide and are recaptured. As shown in FIG. 22 and FIG. 23, this method becomes part of the initial incubation and enables extraction of pathogens from the entire volume of sample. The bacterial quantity inside of the tube reaches sufficient levels for detection in an early stage of pre-enrichment (starting with 1 single cell propagation to 1000 bacteria takes less than 3 hours (assuming a 20-minute doubling time and unstressed/uninjured parent cells)). Beneficially, there is no need for diluting or aliquoting unlike other techniques. Furthermore, multiple tubes with antibodies can be used with a single sample enabling pathogen identification and/or multiple pathogen detection simultaneously. Thus it is possible to use this technology as a diagnostic tool as well as a pre-concentration tool reducing time, cost, and effort.

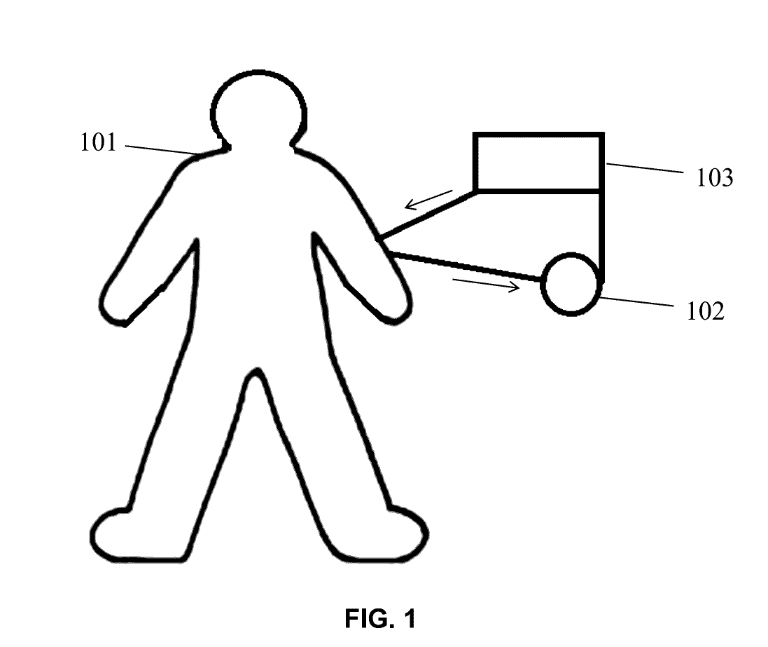

According to an embodiment of the present invention, the invention can utilize binding materials, such as biological binders (i.e. antibodies), to trap microorganisms. The invention may utilize binding material in the form of biological binders, such as antibodies or peptides, to trap a disease causing agent such as a pathogen, cell, cancer cell, polymer, chemical compound, folic acid, pathogen reporter, or pathogen byproduct. According to an embodiment of the present invention, as shown in FIG. 1, a fluid sample (such as a patient's blood (101)) is moved by a pump (102) and flown through an entrapment chamber that has a binding material coated on its inner walls. The binding material captures a target material. The chamber comprises an inlet, through which the fluid sample flows into the chamber, an outlet, through which the fluid sample flows out of the chamber, an inner portion coated with a binding material, and an outlet tube connected to the outlet of the chamber which returns the fluid sample to the fluid source (e.g. the container that is holding the sample or the body of a patient). The flow is continuous until there is enough target material captured for analysis.

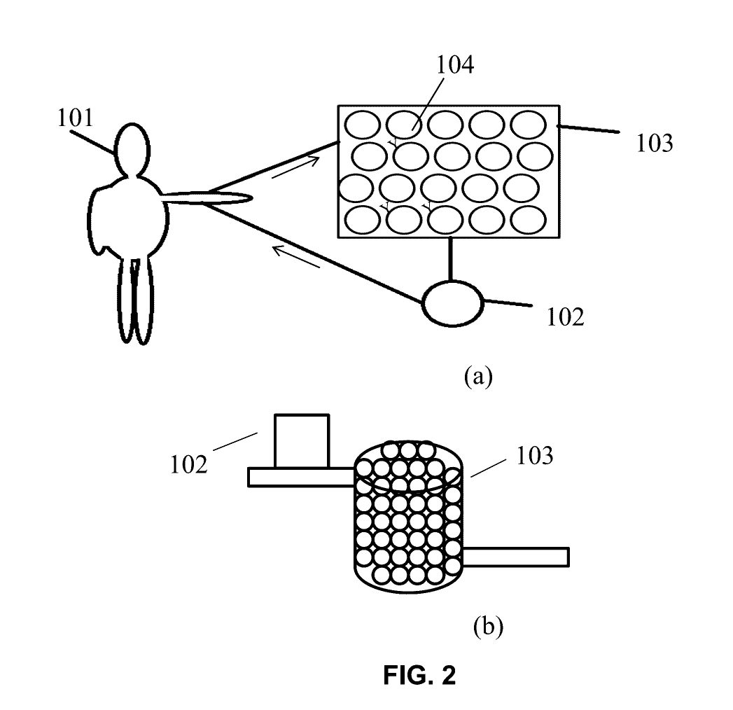

According to an embodiment of the present invention, as shown in FIG. 2 (a), the patient's blood (101) is moved by a pump (102) and flown through the chamber (103). After the process is complete, the patient's blood (101) is injected back in the patient. In some embodiments, the chamber (103) contains spheres with specific binding materials, such as antibodies (104), to that target and bind to the specific particles that are desired to be removed. In some embodiments, as shown in FIG. 2(b), the chamber (103) is a column partially or entirely backed with beads, for instance a glass bead column. The glass tube varies in diameter, for example it varies from 1 mm to 50 mm and a height of 5 cm to 1 m. In some embodiments, the beads are pre-coated with binding material to trap the target agents. Gravity or a pump (102) is used to flow the fluid over the beads. The beads may be made of any suitable material including, but not limited to glass, silica gel, or any other kind. In the preferred embodiment, the diameter of the beads may have an array of ranges from 1 micron, 10 microns, 40-63 micron, 63-200 micron, 0.5 mm, 1 mm.

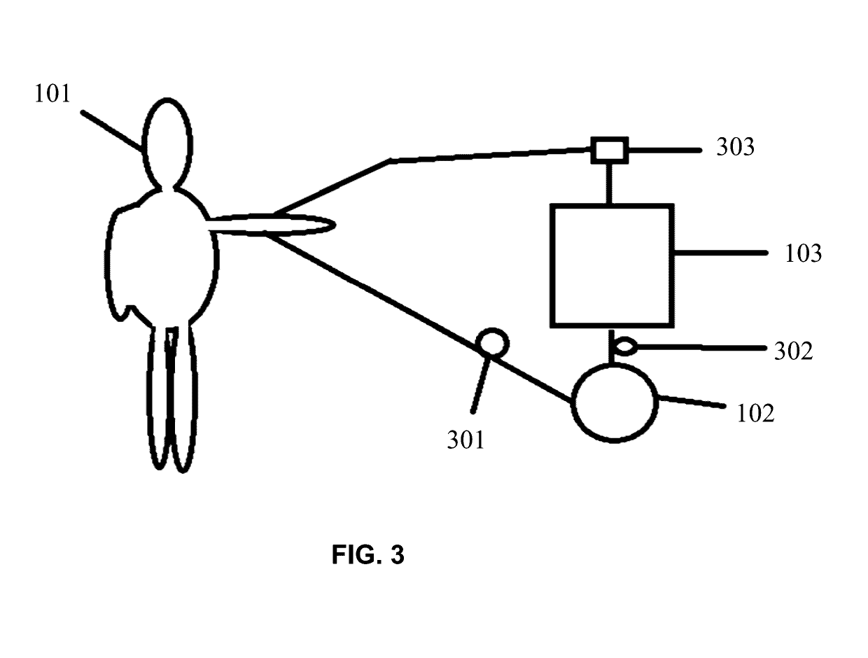

According to an embodiment of the present invention, as shown in FIG. 3, a pressure monitor (301) may be used to measure arterial pressure. In some embodiments, an anticoagulant (such as heparin) pump (302) and an inflow pressure monitor may also be included. In some embodiments, a pressure monitor and/or an air trap and air detector (303) are also included. Certain embodiments of the present invention may include fewer or additional components and the present invention may be used with any combination of the mentioned and additional components to achieve the desired functionality. One of ordinary skill in the art would appreciate that the chamber may be configured with any number of components based upon the desired functionality for the chamber, and embodiments of the present invention are contemplated for use with any such component.

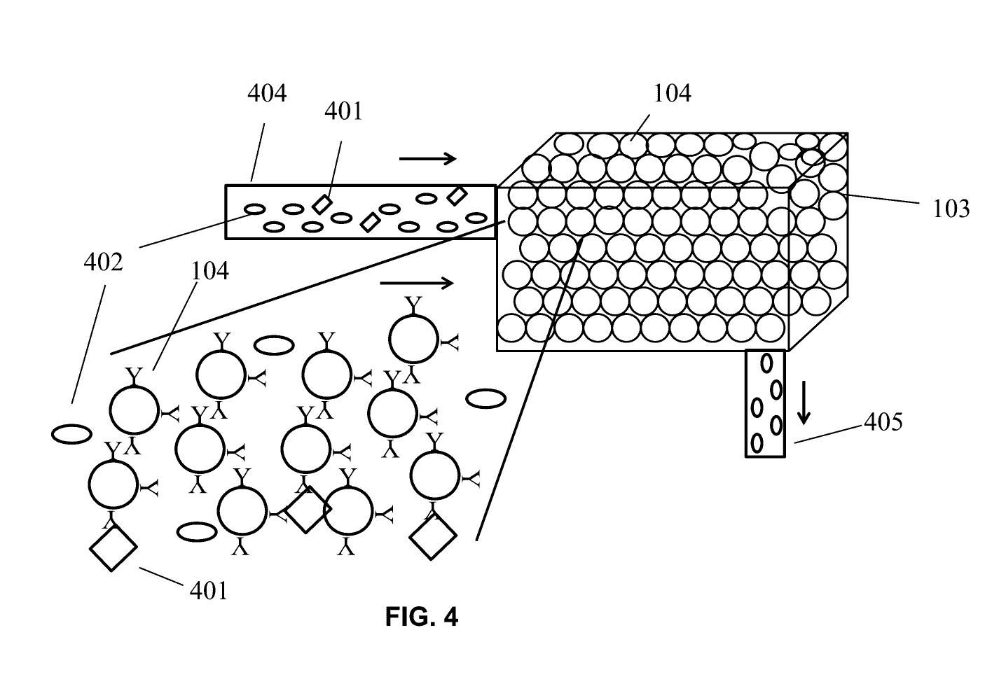

According to an embodiment of the present invention, as shown in FIG. 4, a complex mixture sample solution flows through a tube to the chamber. In the preferred embodiment, the chamber (103) includes spheres with binding material (104). In some embodiments, the binding materials are antibodies or aptamers specific to the cell surface marker of the cells that are being targeted for capture, such as foodborne pathogens (401). As a disease causing agents (401) flow through the chamber (103) they are captured and removed (as shown in FIG. 4). In some embodiments, the surface of the chamber (103) or of the sphere (104) (or of the tube or of the pillar) is a nanorough surface that captures agents. A nanorough surface possesses nanometer scale roughness. A microrough surface possesses micrometer scale roughness. One of ordinary skill in the art would appreciate that the chamber could be used with any binding material, and embodiments of the present invention are contemplated for use to target and capture any cell type.

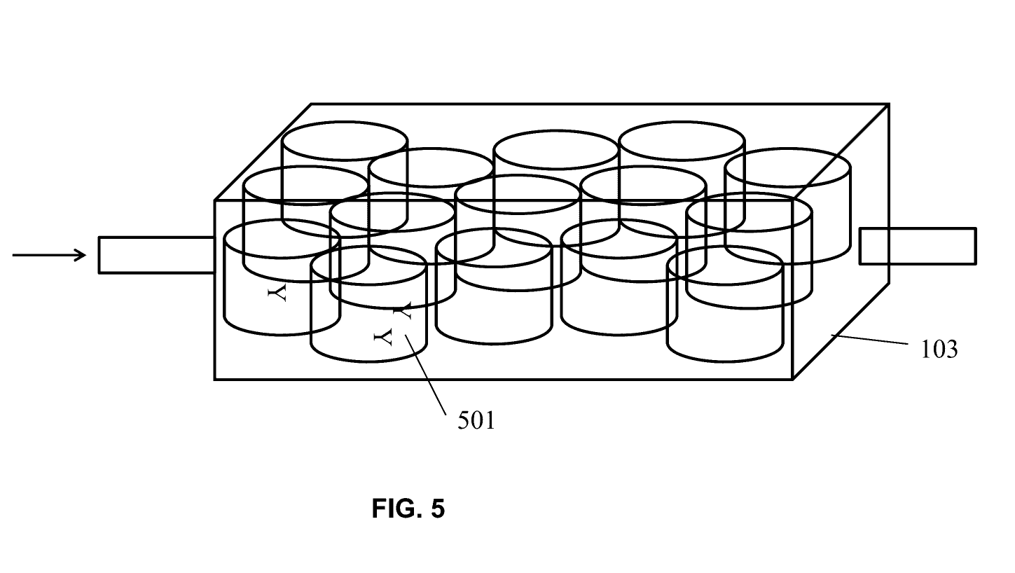

According to an embodiment of the present invention, in FIG. 5, the chamber (103) includes pillars (501) coated with binding material. In a preferred embodiment, the pillars are tightly positioned to increase the chances that the desired particles will collide with and stick to the pillars. One of ordinary skill in the art would appreciate that there would be many useful patterns and arrangements that the pillars could be positioned in, and embodiments of the present invention are contemplated for use with any such arrangement.

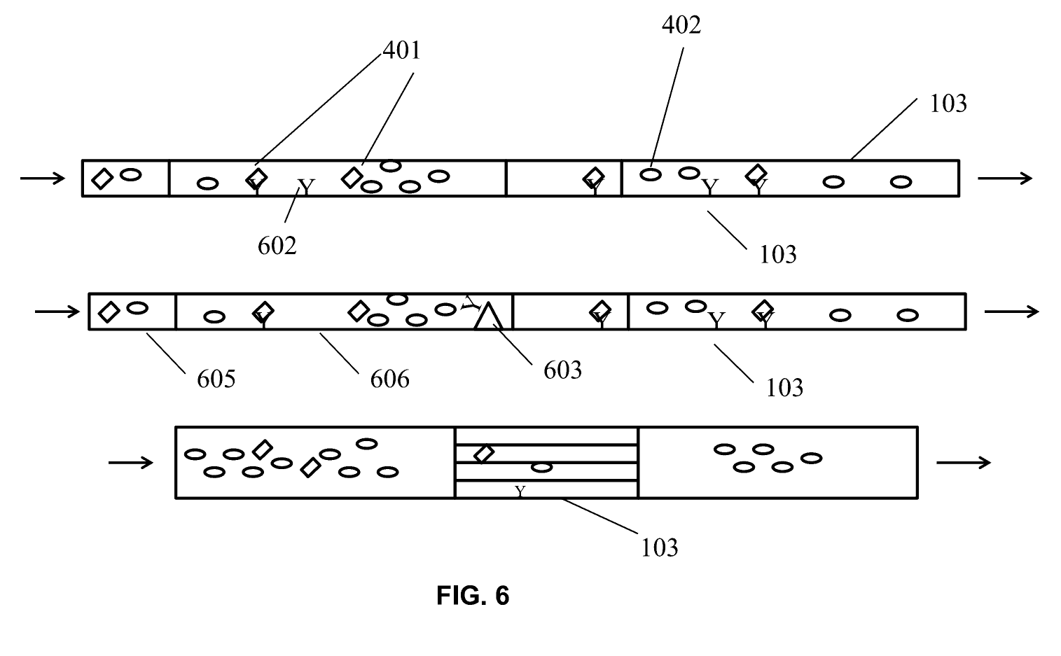

According to an embodiment of the present invention, as shown in FIG. 6, the chamber is composed of tubes (103), for example flexible tubes, coated with binding material (603) such as adhesion protein. In some embodiments the flexible tube includes a nanorough or microrough surface. In some embodiments, multiple tubes join together (for example 605 and 606), with each tube having different binding materials (602), such as different antibodies for separate diseases. In a preferred embodiment, this allows the chamber to capture and concentrate multiple targets of disease causing agents such as Salmonella, E-Coli, and Listeria simultaneously. In a preferred embodiment, as complex sample mixture solution flows out of the reservoir and into the chamber, the solution passes from each chamber (tube) trapping unwanted disease causing agents (such as foodborne pathogens). In some embodiments, as shown in FIG. 1, a pump is used to move the solution through the chamber. Ultimately, the cleaned solution is returned to the reservoir or the body. In some embodiments, the tubes are pre-coated with a binding material. In some embodiments the tubes are coated by flowing various chemicals and biomolecules, including binding agents, through the tubes before connecting the device to sample. In some embodiments, the tubes include barriers (constriction areas) (603) to make cells and flowing material collide with the tube walls or barriers in order to increase the probability of capture. According to an embodiment of the present invention, the tubes are flexible. In a preferred embodiment, the tubes are spiral or otherwise meandering in shape. In alternate embodiments, the tubes may be rigid and straight in shape. One of ordinary skill in the art would appreciate there any many suitable designs for a tube, and embodiments of the present invention are contemplated for use with any such tube design.

According to an embodiment of the present invention, after flow is completed, the chamber (for example the tube or tubes) is be used to analyze the remaining cells via florescent tagging or imaging or other techniques such as cytometry. Similarly, PCR techniques, ELISA, fluorogenic, electro-chemiluminescent, or chromogenic reporters or substrates that generate visible color change to pinpoint the existence of antigen or analyte or gene may be used. In some embodiments, the captured pathogen may be released using releasing agents, such as trypsin, or the pathogen is directly lysed inside the tube and PCR is used.

In some embodiments, (arrangement shown at the bottom of FIG. 6) multiple micro-tubes are used. As previously, these micro-tubes are functionalized with binding material (such as capturing, binding, or killing) (602). The small size of the chamber increases the capturing probability, while the large number of the small size tubes in parallel increases the throughput. For example, a tube with diameter 20 micron, or 10 micron, or 30 micron, or 50 micron, or 100 micron or 500 micron or 1 mm or less than 2 mm is used.

A chamber is one or more chambers selected from a group of chambers comprising tube, cylindrical shape, parallelepiped with hollow interior, or rectangular parallelepiped. In some embodiments, the parallelepiped design includes a hollow interior with a height of 0.5 mm and a width and length 1 meter by 1 meter, with an inlet and an outlet. In some embodiments, the height is 1 mm. In some embodiments, the design includes a plurality (multiple) channels running in parallel or meandering but joining at the inlet and the outlet; the height on the channels is 0.5 mm or 1 mm; the length of the channels is 1 mm and the width is 1 mm. In some embodiments, the chamber is of cylindrical shape packed with spheres. In some embodiments, said spheres are 100 micron in diameter and are coated with said binding material. In some embodiments, the chamber is transparent.

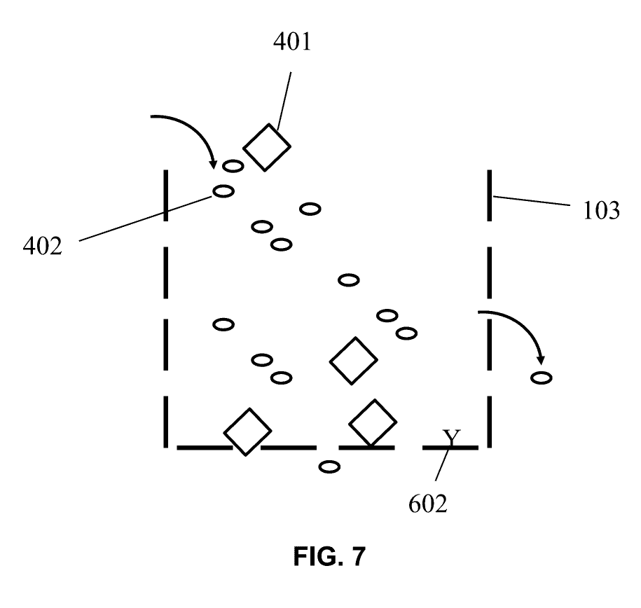

According to an embodiment of the present invention, as shown in FIG. 7, a chamber that uses filtering is used to separate wanted (402) from unwanted material in the complex sample solution. As an illustrative example, CTCs are larger than blood cells. In some embodiments, a binding material (for example binding biomolecule) (602) such as an antibody is coated on the walls of the chamber or on the filter so that the unwanted (401) particle is captured. In some embodiments, osmosis is used (much like in dialysis). In some embodiments, the filter is made of micro-fabricated material, including, but not limited to PDMS or other material like polyimide with micron size holes (e.g. example 10-micron size holes). In some embodiments, the blood is returned to the patient (i.e. removal of blood from the patient and cleaning of the blood, followed by reinjection). In some embodiments, blood is transfused to the patient. Alternatively, blood is mixed with functionalized microbeads with conjugated antibodies or binding material. In some embodiments, several beads with different binding material such as antibodies are included. In the preferred embodiment, the cells or material that are to be captured by binding to the functionalized beads. As the cells flow, the cells are trapped by the filter because the cells are larger than the opening in the filter. In some embodiments, blood is mixed with the beads in a separate container and then the mixture is inserted in the chamber.

As an illustrative example, CTCs are larger than other cells in the blood such as leukocytes, red blood cells, and platelets. For instance, CTCs may have diameters 12-25 microns, therefore a 10 micron opening in the filter may block CTCs from going through, while allowing blood cells, which are 90% smaller, to pass through. In some embodiments, centrifugation is used to separate cells with the centrifugal force based on density. Alternatively, hydrodynamic sorting is used. One of ordinary skill in the art would appreciate that many filtering methods exist to enhance the removal of unwanted material from the blood, and embodiments of the present invention are contemplated for use with any such filtering method or any combination thereof.

CTCs are captured using specific antibodies able to recognize specific tumor markers such as EpCAM. In some embodiments of the present invention, the spheres, tubes, pillar, filters, or walls (or any combination thereof) of the chamber are coated with a polymer layer carrying biotin analogues and conjugated with antibodies anti EpCAM for capturing CTCs. After capture and completion, images can be taken to further diagnose disease progression by staining with specific fluorescent antibody conjugates. Antibodies for CTC capture include, but are not limited to, EpCAM, Her2, PSA.

According to an embodiment of the present invention, as shown in FIG. 6, the chamber is composed of tubes (103), for example flexible tubes, coated with binding material (603) such as adhesion protein. The tube is made of a material selected from the group of materials consisting of, but not limited to, glass, quartz, plastic, PDMS, SU-8, polyimide, paralyne, metals, iron, iron oxides, or other materials. In some embodiments, the tube is transparent. In some embodiments, the inner surface of the chamber (i.e. tube) is modified to be receptive to the binding material, for example to a specific antibody or peptide coating. In some embodiments, the chamber (such as a simple tube) is coated with peptides. In some embodiments, the patient's blood flows through the chamber (such as a simple tube), but then flow is stopped so that the relevant disease causing agent is allowed to adhere to the binding material on the surface of the chamber. Next, the fluid or solution is flown out of the chamber (such as a simple tube) after having given enough time to maximize capturing. In an embodiment, the blood may be flown back out of the chamber after thirty (30) to sixty (60) minutes. In alternate embodiments, the blood may be flown back out the chamber after a longer or shorter period depending upon the amount of time required to collect the unwanted material. In some embodiments, the flow rate is 0.5 mL/min. In other embodiments, the flow rate is below 5 mL/min. One of ordinary skill in the art would appreciate this amount could be adjusted accordingly based on the particular application. In some embodiments the tube has a spiral shape, while in others the tube has a stacked spiral shape. One of ordinary skill in the art would appreciate that there are many suitable shapes for a tube, and embodiments of the present invention are contemplated for use with any such tube shape.

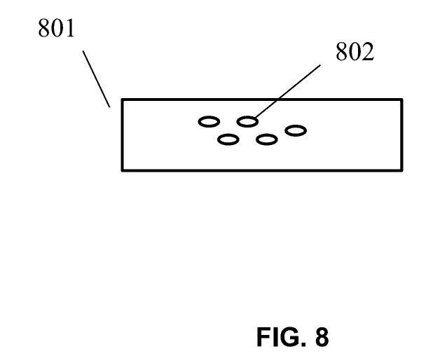

According to an embodiment of the present invention, as shown in FIG. 8, a chamber 801 with captured material 802 (such as cancer cells) are previously fluorescently tagged with florescent die. For example, FITC labeled antibody is used to tag the cells that have been captured in the chamber. Next, the florescent cells are counted. In some embodiments an automated system is used to count the cells. The system may include a software system and CCD camera to count the cells. In some embodiments, the entire chamber is counted. For example, the florescent cells attached to the inner part of the tube are counted by examining the tube outer part. The tube may be rotated to enumerate the cells on all the sides of the tube. In some embodiments, an area is counted and the total number of cells captured is extrapolated from the cell count. In some embodiments, the counting is conducted after the capture is completed and the rest of the fluids such as whole blood are removed. One of ordinary skill in the art would appreciate that there are numerous methods to tag and count the cells that are captured, and embodiments of the present invention are contemplated for use with any such method.

According to a first preferred embodiment of the present invention, there is continuous flow through the chamber. In an alternate preferred embodiment, the chamber is filled with blood and the flow is stopped for a specific time (for example for 30 minutes), then flow is resumed until the chamber is full again and the step is repeated.

According to an embodiment of the present invention, the chamber is exposed to radiation for radiation therapy in order to kill the disease causing agent (example: cancer cells or other materials and cells that are malignant). In some embodiments, chemotherapy agents are coated on the surface of the chamber. As cells flow through the chamber, they collide with the surface of the chamber and die or attach and die if antibody capturing is also used in combination with chemotherapy agents. In some embodiments, chemical substances, such as one or more anti-cancer drugs, are used. In some embodiments, drugs that are not indiscriminately cytotoxic (such as monoclonal antibodies) are coated on the surface of the chamber. These drugs target specific proteins expressed specifically on the cells that have to be removed, such as proteins on a bacterium or cancer cell.

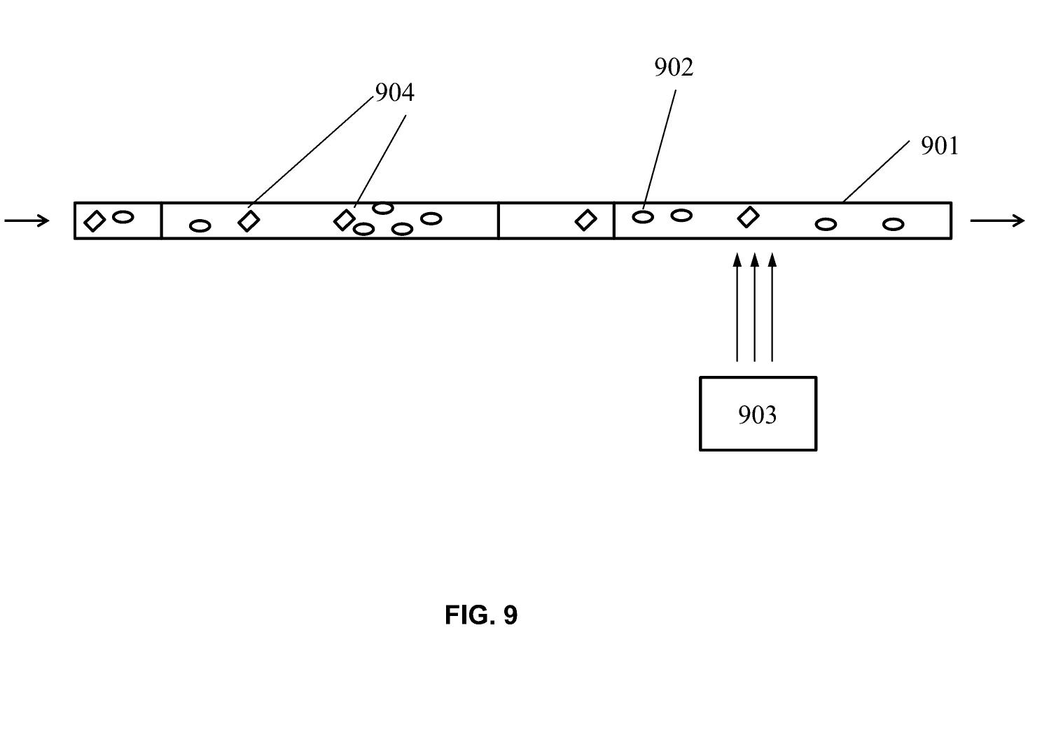

According to an embodiment of the present invention, as shown in FIG. 9, light exposure 903 is included in a way such that the chamber 901 is exposed to light to achieve photochemotherapy (also referred to as photodynamic therapy or PDT). In a preferred embodiment, the disease causing agent 904 flows and is captured by the coated tube. A number of tubes are connected in series each one coated with different antibodies.

According to an embodiment of the present invention, the chamber is a modified commercially available plastic tube that is coated with a binding material such as antibodies. In some embodiments, a complex sample solution flows through a tube where disease causing agents bind to antibodies coated on the inner surface of the tube. In the preferred embodiment, this procedure can be done safely and successfully in a clinical setting by (i) processing the entire blood in continuous circulation or (ii) consecutive drawing of as much as 0.5 liter of blood (a quantity in line with typical blood donations).

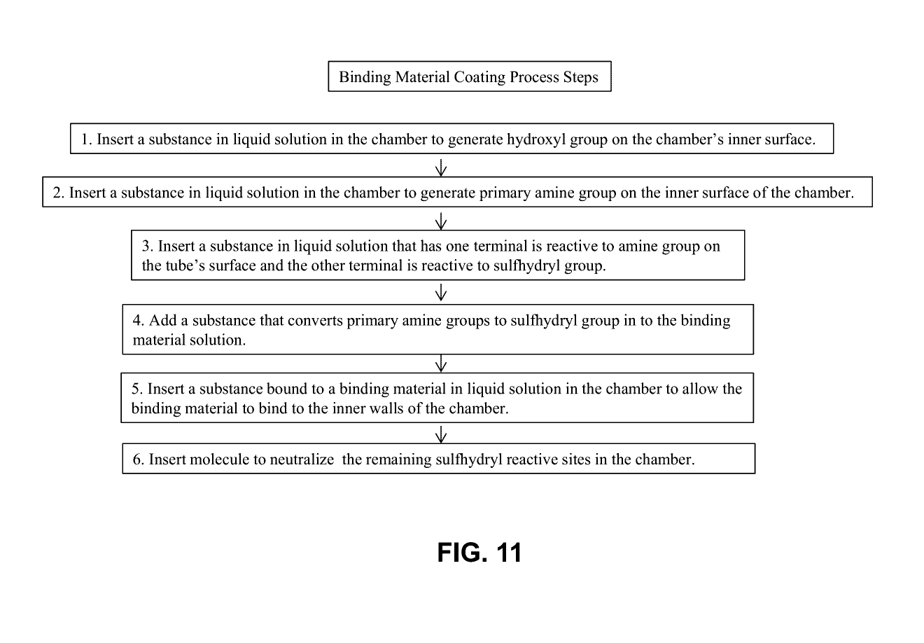

Turning now to FIG. 11, an exemplary process of applying the binding material to the chamber (such as tube, here tube is used as an example) comprises the following steps: (1101) PDMS tube is treated by hydrogenperoxide (H₂O₂):hydrochloric acid (HCL):water (H₂O) mixture. This treatment can generate hydroxyl group (—OH) on the PDMS tube inner surface. (1102) The tube is treated by aminopropyltrimethoxysilane (APTMS) (or aminopropyltriethoxyxilane (APTES)). This step can produce primary amine group on the tube surface. (1103) The tube is filled with Sulfosuccinimidyl-4-(N-maleimidomethyl)cyclohexane-1-carboxylate (Sulfo-SMCC) solution (in buffer at pH 7.4). Sulfo-SMCC is a hetero-bifunctional-crosslinker (one terminal is reactive to amine group and the other terminal is reactive to sulfhydryl group). (1104) At the same time, 2-iminothiolane (2-IT) is added to antibody solution and the mixture is stirred at room temperature in a vial (not inside the tube yet). 2-IT converts primary amine groups in the given antibody to sulfhydryl group (—SH). Then, the excess 2-IT is removed from antibody solution by centrifugal filtration and the excess Sulfo-SMCC is removed from the tube (excess Sulfo-SMCC is defined as the Sulfo-SMCC that is unbound to the tube). (1105) Product from step3-b, which is the antibody solution, is injected in the tube following step 3 a (in step 3 a the tube have been treated with Sulfo-SMCC). This step allows the sulfhydryl group on the antibody to react with sulfhydryl reactive terminal of sulfo-SMCC, resulting in antibody coated tube inner surface by covalent linkage. (1106) The antibody conjugated tube surface is treated by cystein solution. Cystein (an amino acid with —SH group) can cap the remaining sulfhydryl reactive site of tube and neutralize the electric charge of the tube surface. One of ordinary skill in the art would appreciate that there a number of modifications that could be made to the above described steps without departing from spirit and scope of the present invention.

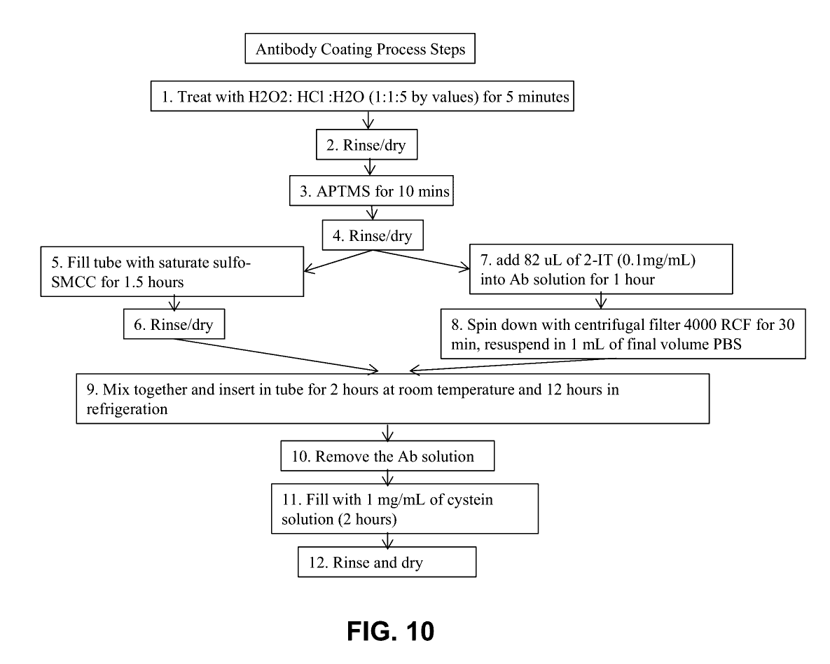

According to an embodiment of the present invention, a polydimethylsiloxane (PDMS) tubing (laboratory tubing with 1.02 mm in inner diameter) can be used. The tube's internal surface is activated by treating with acidic hydrogenperoxide solution (H₂O:HCl:H₂O₂ in 5:1:1 volume ratio) for 5 minutes at room temperature (FIG. 10 step 1001). The tube is rinsed with excess deionized (DI) water 5 times and dried in air (FIG. 10 step 1002). This forms the hydrophilic surface with hydroxyl groups available for further functionalization. Then, the tube is filled with aminopropyltrimethoxysilane (APTMS) for 10 minutes (FIG. 10 step 1003). The tube is rinsed with excess amount of DI water at least 5 times and dried in air. This step adds the primary amine group on the surface based on the sol-gel reaction principle (FIG. 10 step 1004). Then, the tube is rinsed and the fluorescence from tube's inner surface is monitored using fluorescence microscope.

EpCAM is a widely accepted CTC marker due to CTC's epithelial origin. Therefore, according to an embodiment of the present invention, EpCAM antibody is treated with Traut's reagent (2-iminothiolane HCl, 2-IT) to generate an available sulfhydryl group (—SH) (anti-EpCAM:2-IT=1:10 in mole ratio) in PBS (pH 7.4) for 1 hour (FIG. 10 step 1007). Then, unbound 2-IT is removed from the antibodies using centrifugal filter (MWCO 30 kDa, Amicon filter or Corning Spin-X protein concentrator) at 4000 RCF for 30 minutes (FIG. 10 step 1008). The concentrated anti-EpCAM is resuspended in PBS, adjusting the volume of 1 mL. During the antibody-2-IT reaction, the amine functionalized tube is filled with a hetero-bifunctional (amine reactive at one terminal and thiol reactive at the other terminal) cross-linker, sulfo-SMCC (sulfosuccinimidyl 4-[N-maleimidomethyl]cyclohexane-1-carboxylate) in 2 mg/mL concentration in PBS (pH 7.4) (FIG. 10 step 1005). After the EpCAM is spinned down, the sulfo-SMCC solution is removed from tube, and the tube is rinsed in PBS and re-filled with 1 mL EpCAM solution (FIG. 10 step 1006). The reaction is run for 2 hours at room temperature and kept on going overnight at 4° C. on a shaker (FIG. 10 step 1009). The next day, after the unbound EpCAM solution is collected (FIG. 10 step 10), the tube is gently rinsed with PBS and then refilled with 1 mg/mL L-cystein for further 2 hours (FIG. 10 step 1011). The tube is rinsed and dried (FIG. 10 step 1012). The conjugation of anti-EpCAM on the tube surface is confirmed by PE's fluorescence on a fluorescence microscope. One of ordinary skill in the art would appreciate that there a number of modifications that could be made to the above described steps without departing from spirit and scope of the present invention.

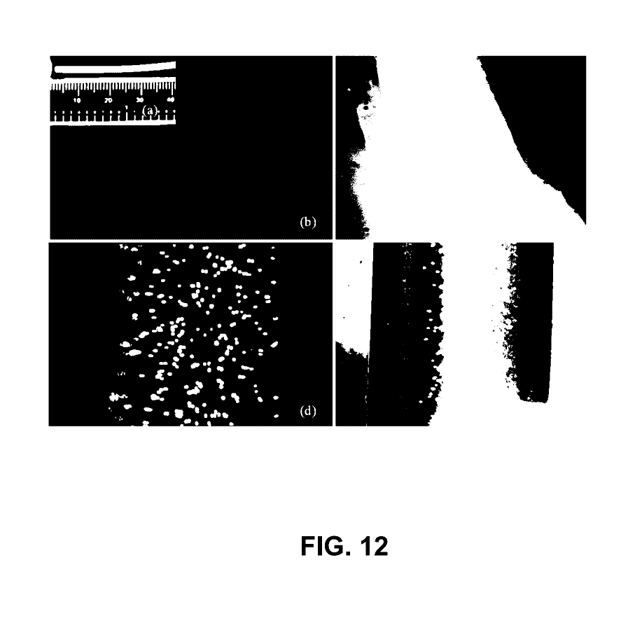

Turning now to FIG. 12, at element 1201 (a) a tube, like the one shown in the picture, are functionalized with human anti-EpCAM (ruler scale in mm) as described above. As shown in 1201 and 1202, PC-3 cells were placed in an unmodified tube (without EpCAM coating), for control measurements, no capture was observed. As shown in 1203 and 1204, fluorescent microscopic images of captured PC-3 cells on anti-EpCAM immobilized tube (light areas shown in the tubes). The images in 1203 and 1204 are of captured PC-3 cells by anti-EpCAM conjugated silicone (PDMS) tube after 1 hour of incubation. After collecting the solution from tube, captured cells were stained with Calcein AM containing cell media and imaged using GFP filter cube (Ex: 485 nm/Em: 525 nm) with an Olympus IMT-2 fluorescence microscope. The result showed that PC-3 cells were effectively captured by the anti-EpCAM immobilized tube. Due to the fact that Calcein AM is a cell viability indicating fluorescent probe, these images also confirm that the captured cells are alive. In contrast the unmodified control tubes, shown in 1201 and 1202, exhibited negligible capture of PC-3 cells.

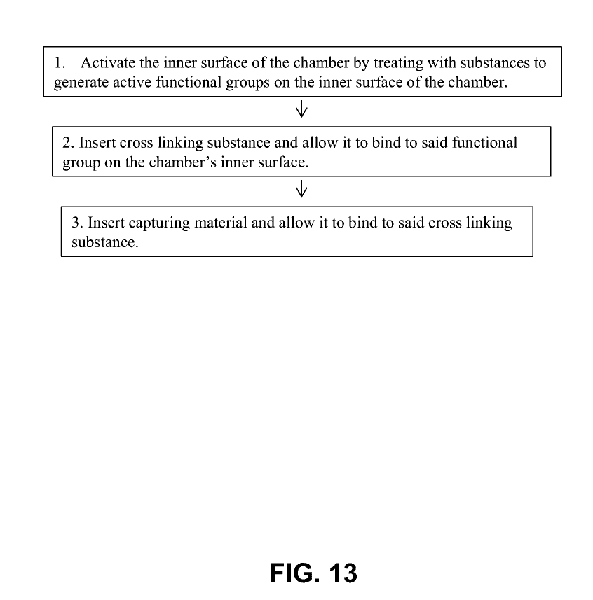

Turning now to FIG. 13, an exemplary process to functionalize chamber such as a tube for capturing specific substances may comprise the following steps: (1301) activate the inner surface of tubing by treating with substances to generate active functional groups on the inner surface of the tube; (1302) insert cross linking substance and allow it to bind to said functional group on the tube's inner surface; (1303) insert binding material and allow it to bind to said cross linking substance. In a preferred embodiment, said binding material is designed to bind to disease causing agent. According to an embodiment of the present invention substances to generate active functional groups are selected from the group of active functional group generating substances comprising acidic hydrogenperoxide solution (H₂O:HCl:H₂O₂ in 5:1:1 volume ratio), aminopropyltrimethoxysilane (APTMS). According to an embodiment of the present invention cross linking substances are selected from the group of cross linking substance comprising 1-Ethyl-3-[3-dimethylaminopropyl]carbodiimide hydrochloride (EDC or EDAC), sulfo-SMCC (sulfosuccinimidyl 4-[N-maleimidomethyl]cyclohexane-1-carboxylate), and polymeric linkers.

According to an embodiment of the present invention, the chamber is a medical tube. In a preferred embodiment, the tube is selected from a group of tube comprising plastic tubes, polymer tube, metallic tube, silicone tube, glass tubes. In some embodiments, the captured cells on the tube are counted and further re-suspended and genetically analyzed, or re-cultivated. In some embodiments, additional filters and apoptosis causing agents are added to enhance the capture/kill rate. In some embodiments, the system is part a dialysis machine. In some embodiments, a machine that includes the tube also includes anticoagulant inlets, filters to filter cells by size (for example 25 μm size separation holes), and photodynamic therapy. In some embodiments, a dialysis membrane is added to remove microorganisms by their smaller size.

According to an embodiment of the present invention, a method for preparing a chamber such as a tube to be used for capturing disease causing agent, said method comprising the steps of: activating an inner surface of the tube by treating the inner surface with substances to generate active functional groups on the inner surface of the tube; inserting into the tube a crosslinking substance such that the crosslinking substance binds to said functional group on the inner surface of the tube; inserting binding material into the tube such that the binding material binds to said crosslinking substance, wherein said binding material is designed to bind to said substances. In a preferred embodiment, the tube is selected from a group comprising plastic tube, polymer tube, metallic tube and silicone tube. In a preferred embodiment, the present substance to generate active functional groups is selected from the group comprising acidic hydrogenperoxide solution (H₂O:HCl:H₂O₂ in 5:1:1 volume ratio) and aminopropyltrimethoxysilane (APTMS). In a preferred embodiment, the crosslinking substance is selected from the group comprising 1-Ethyl-3-[3-dimethylaminopropyl]carbodiimide hydrochloride (EDC or EDAC), sulfo-SMCC (sulfosuccinimidyl 4-[N-maleimidomethyl]cyclohexane-1-carboxylate), polymer, polymeric linker and Polyethylene Glycol (PEG). In a preferred embodiment, the binding material is selected from the group comprising antibodies, aptamers, peptides, polymers, proteins, nucleic acid, RNA, DNA, organic materials, and magnetic particles.

According to an embodiment of the present invention, a method for preparing a chamber such as a tube to be used for capturing disease causing agent, said method comprising the steps of: activating an internal surface of the tube by treating the internal surface with an acidic hydrogenperoxide solution to form a hydrophilic surface with hydroxyl groups; filling the tube with aminopropyltrimethoxysilane to add a primary amine group on the internal surface; treating an antibody with a solution to generate available sulfhydryl group (—SH); filling the tube with a hetero-bifunctional cross-linker; removing the excess hetero-bifunctional cross-linker solution from tube; filling the tube with the antibody solution; and filling the tube with L-cystein.

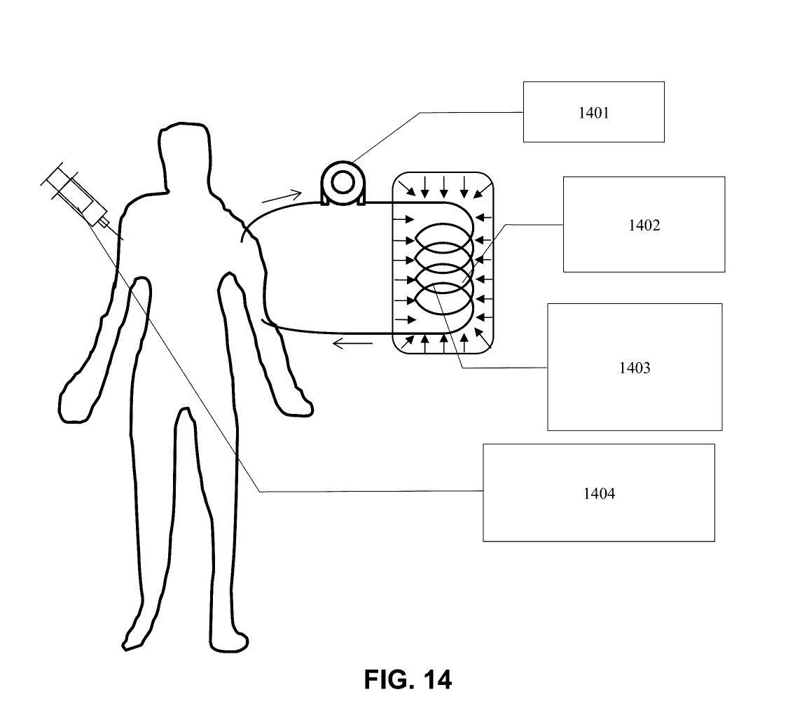

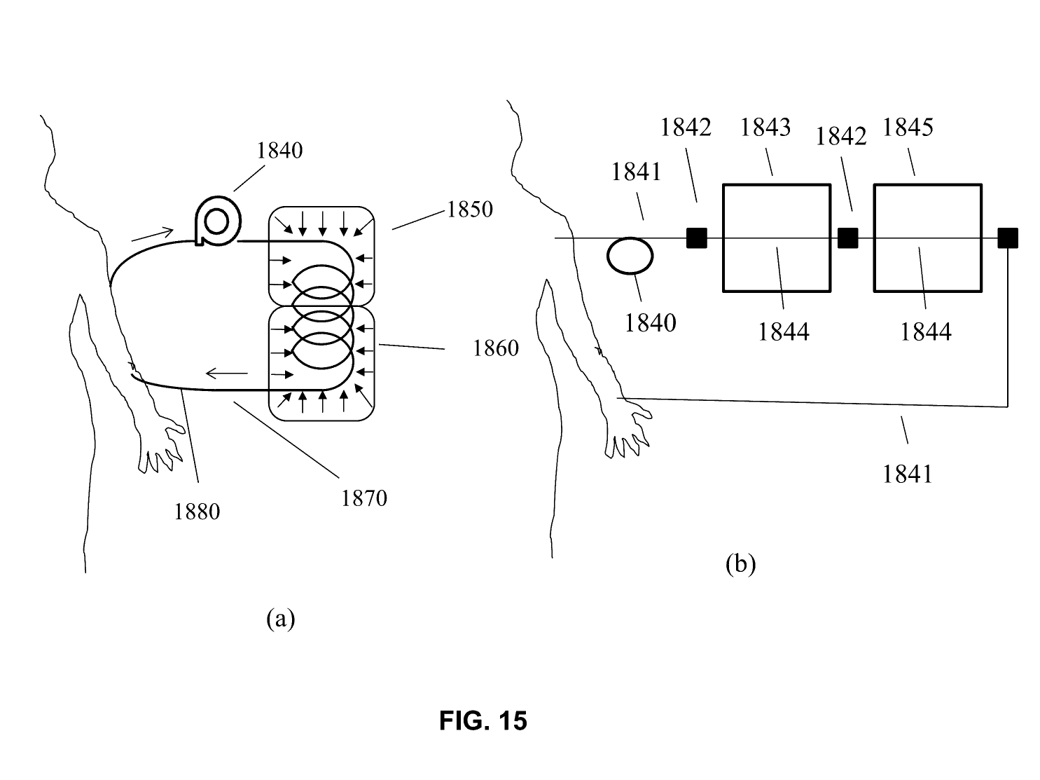

FIG. 14 is a schematic of the proposed chamber in operation, in accordance with an embodiment of the present invention. According to an embodiment of the present invention, a method and apparatus for blood borne pathogen removal that involves capturing (and killing pathogens) by circulating the blood through a chamber and returning the cleansed blood back to the individual is described. Three independent techniques and their combination are disclosed and shown in FIG. 15 together. The techniques include (a) a chamber such as a chemically modified medical tube for capturing and removing pathogens, (b) a photosensitizer that adheres to the pathogens while in circulation (in some embodiments by conjugating the photosensitizer with an antibody) and is activated by near-IR light when the fluid flows through a chamber, such as an extracorporeal tube, whereby the photosensitizer kills the pathogens by releasing ROS, and (c) a chamber such as an extracorporeal tube that is exposed to a light source with UV-light to kill pathogens.

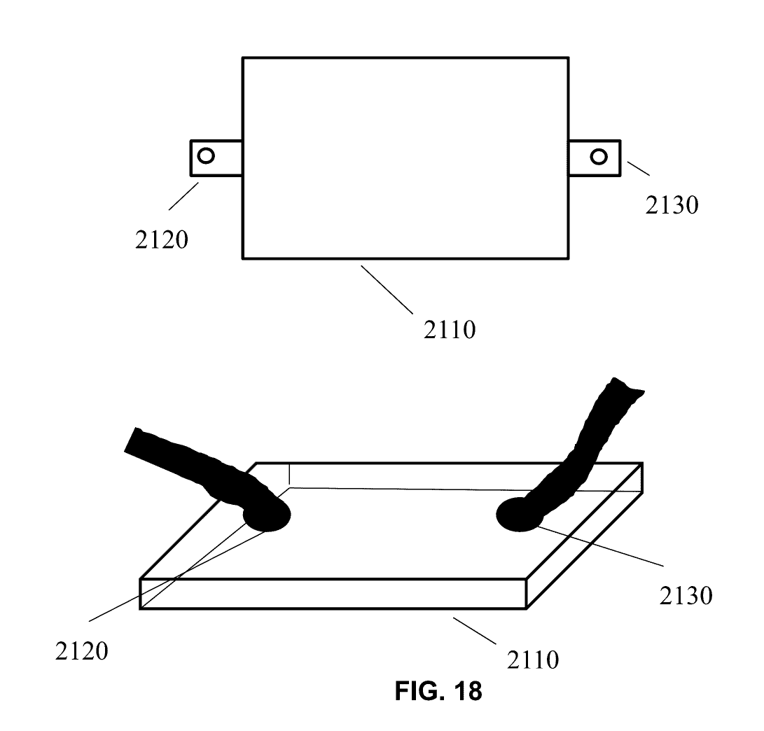

In FIG. 15 (a), a conceptual diagram of extracorporeal chamber is shown, in accordance with an embodiment of the present invention. The blood is circulated through the chamber, for instance a tube, using a pump, for instance a peristaltic pumping. A medical tube circulates the blood of a patient. A pump (1840) helps circulate the blood into a chamber where a light source exposes the chamber (for example the tube) to near-IR (wavelength ˜660 nm) (1850) and UV (wavelength 400 nm-100 nm) (1860) light. The blood is then sent through a second chamber with binding material, for instance a functionalized tube (1870) for capturing the targeted material (such as pathogen or pathogens). The photosensitizer-antibody conjugate is administered through the administration port (1880). In some embodiments, shown in FIG. 18 (b), the chamber is cooled or placed inside another chamber with lower temperature, for instance at a temperature of 4 Celsius. In some embodiments, only the coated section (or part) with binding material of the chamber is cooled. The blood goes through the first tube (1841). A pump (1840) is used to circulate the blood through the first chamber (for instance a second tube) (1844) coated with binding material. The tube is connected to the chamber (1844) via a tube connector (1842). The chamber (1844) resides partially or entirely inside a cooling chamber (1843). Another connector (1842) connects the chamber (1844) to a second chamber (for instance a second tube) (1844) where a light source exposes it to light of a specific wavelength defined elsewhere in this disclosure. Finally, via another connector to a tube, the clean blood is returned.

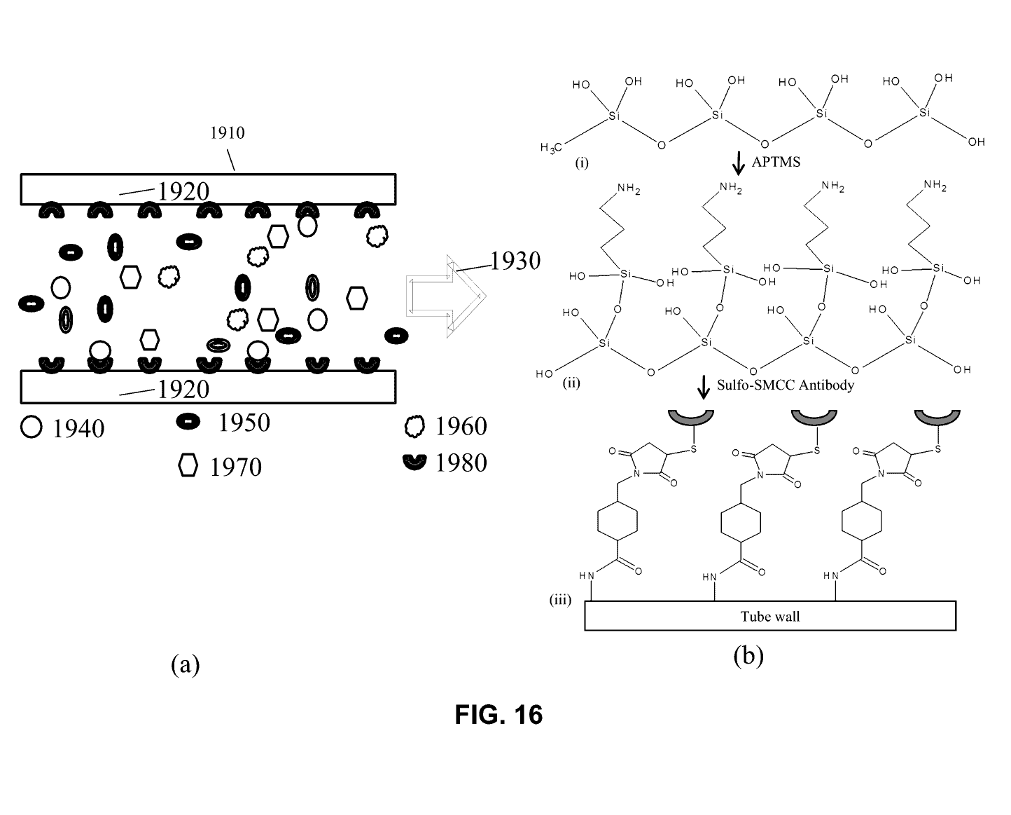

FIG. 16 is a conceptual diagram of capturing by binding material, such as antibody immobilized on chamber (for example a tube), in accordance with an embodiment of the present invention. A chamber with binding material (such as a functionalized tube) (1910) is shown. The tube wall (1920) in this example is coated with binding material which is an adhesion molecule (such as antibody) or pathogen killing molecule (1980). As blood flows (1930), the pathogens (1940) are captured or killed, while the red blood cells (1950), platelets (1960), white blood cells (1970) flow back to the patient.

In some embodiments, the chamber is a polydimethylsiloxane (PDMS) tubing (in some embodiments it has an internal diameter of 1.02 mm). According to an embodiment of the present invention, the chamber is prepared as follows: the chamber's internal surface is activated by with an acidic hydrogen peroxide solution (H₂O:HCl:H₂O₂ in 5:1:1 volume ratio) for five minutes at room temperature. The chamber is then rinsed with excess deionized (DI) water five times and dried in air. This leads to the hydrophilic surface with hydroxyl groups (—OH) available for further functionalization. Next, the chamber is filled with aminopropyltrimethoxysilane (APTMS) for 10 minutes. The chamber is rinsed again with excess DI water at least five times and dried in air. This final step adds the primary amine group on the surface based on the sol-gel reaction principle. To verify the presence of the primary amine group on the tube surface, a short section of the treated chamber is filled with an amine reactive fluorescence dye, fluorescein isothiocyanate (FITC, 0.1 mg/mL in PBS pH 7.4) for one hour. The chamber is then rinsed, and the fluorescence from its inner surface is monitored using a fluorescence microscope. An antibody specific to the microorganism that is targeted is treated with a reagent such as (2-iminothiolane HCl, 2-IT) to generate an available sulfhydryl group (—SH) (antibody:2-IT=1:10 in mole ratio) in PBS (pH 7.4). Then, unbound reagent (such as 2-IT) is removed from the antibodies using a protein concentrator (MW cut off 30 kDa, Corning Spin-X protein concentrator) at 5000 RCF for 30 minutes. The concentrated antibody is re-suspended in PBS, and the volume is adjusted to fill the chamber. During the antibody-reagent reaction, the amine functionalized tube is filled with a hetero-bifunctional crosslinker, sulfo-SMCC (sulfosuccinimidyl 4-[N-maleimidomethyl]cyclohexane-1-carboxylate) in 1 mg/mL concentration in PBS (pH 7.4). Following a spinning down, the sulfo-SMCC solution is removed, and the chamber is rinsed in PBS and re-filled with re-suspended antibody solution. The reaction is run on a shaker for two hours at room temperature and continued overnight at 4° C. The next day, after the unbound antibody solution is collected, the chamber is gently rinsed with PBS and then refilled with 2 mg/mL L-cysteine for another two hours. The conjugation of antibody on the tube surface is confirmed by FITC labeling on a fluorescence microscope. In this example antibody was used for a binding material and a tube for a chamber. Other binding materials and types of chambers can also be used. An apparatus for automated coating preparation is disclosed. The apparatus dispenses the reagents specified above for the required time duration to prepare the chamber. In some embodiments, the apparatus handles more than one chamber at the same time. In some embodiments, the automated apparatus is capable of dispensing commonly used reagents to all the chambers and specific reagents to specific chambers. For example, acidic hydrogen peroxide solution is inserted in all the chambers, while specific binding material is used for each chamber (for instance, chamber 1 receives binding material A that binds to agent A; chamber 2 receives binding material B that binds to agent B).

More specifically, in FIG. 16 (b), a polydimethylsiloxane (PDMS) tubing (Dow Corning Silastic laboratory tubing with an internal diameter of 1.02 mm) is used. According to an embodiment of the present invention, the tube length is approximately 100 cm. The tube's internal surface is activated by treatment with an acidic hydrogen peroxide solution (H2O:HCl:H2O2 in 5:1:1 volume ratio) for five minutes at room temperature. The tube is then rinsed with excess deionized (DI) water five times and dried in air. This forms the hydrophilic surface with hydroxyl groups (—OH) available for further functionalization (FIG. 16 (b) (i)). Next, the tube is filled with aminopropyltrimethoxysilane (APTMS) for 10 minutes (FIG. 16 (b) (ii))). The tube is rinsed again with excess amount of DI water at least five times and dried in air. This step adds the primary amine group on the surface based on the sol-gel reaction principle. To verify the presence of the primary amine group on the tube surface, a short section of the treated tube is filled with an amine reactive fluorescence dye, fluorescein isothiocyanate (FITC, 0.1 mg/mL in PBS pH 7.4) for one hour (FIG. 16 (b) (ii)). The tube is then rinsed and the fluorescence from its inner surface is monitored using a fluorescence microscope. Immobilization of antibody like anti-EpCAM on the surface of the tube is done as follows: in this example Phycoerythrin (PE)—labeled human EpCAM (eBiosciences) antibody (however this process is used with other binding materials as well) is treated for one hour with Traut's reagent (2-iminothiolane HCl, 2-IT) to generate an available sulfhydryl group (—SH) (anti-EpCAM:2-IT=1:10 in mole ratio) in PBS (pH 7.4). Then, unbound 2-IT is removed from the antibodies using a spin column (MW 30 kDa, cutoff, Amicon filter or Corning Spin-X protein concentrator) at 5000 RCF for 30 minutes. The concentrated anti-EpCAM is re-suspended in PBS, and the volume adjusted to of 1 mL. During the antibody-2-IT reaction, the amine functionalized tube is filled with a hetero-bifunctional (amine reactive at one terminal and thiol reactive at the other terminal) cross-linker, sulfo-SMCC (sulfosuccinimidyl 4-[N-maleimidomethyl]cyclohexane-1-carboxylate) in 1 mg/mL concentration in PBS (pH 7.4). After the EpCAM is spun down, the sulfo-SMCC solution is removed and the tube is rinsed in PBS and re-filled with 1 mL EpCAM solution. The reaction is run on a shaker for two hours at room temperature and continued overnight at 4° C. The next day, after the unbound EpCAM solution is collected, the tube is gently rinsed with PBS and then refilled with 2 mg/mL L-cystein for another two hours (FIG. 16 (b) (iii)). The conjugation of anti-EpCAM on the tube surface is confirmed by PE's fluorescence on a fluorescence microscope.

According to an embodiment of the present invention, the inner surface of the device (such as a tube) bound to a binding material (such as an antibody), wherein said binding material is bound by an intermediate molecule to the inner surface. In a specific embodiment, the intermediate molecule contains a succinimidyl ester and a carbon chain and maleimidyl ester. The binding material is bound to the intermediate molecule. In some embodiments, the intermediate molecule is a spacer molecule or a zero-length crosslinking agent or any other crosslinking agent.

According to an embodiment of the present invention, the apparatus includes a peristaltic pump. In a preferred embodiment, a tube passes through a peristaltic pump to maintain the continuous constant flow of the fluid sample (for example blood sample) in the tube. The chamber (for example a tube or several tubes i.e. 100 tubes or 130 tubes) in some embodiments has cube shape and mirror walls in an inner surface to maximize the light and reflect it from all sides. The output of the chamber is connected to a tube which is in return connected to the source (for example a patient). In some embodiments, the initial flow rate is 50 mL/min (or between 30 mL/min and 100 mL/min, the flow rate through the chamber is 0.5 mL/min. In a particular embodiment the tube connected to the source (ie patient or blood container) is at a high flow rate and the flow rate through the device is slower. This is achieved by increasing the cross sectional area of the inlet of the device. For example, a tube of 1 mm diameter is connected to a splitter with 100 tubes of 1 mm diameter dropping the flow rate by 100 times.

According to an embodiment of the present invention, the chambers are unmodified PDMS tubes. In a preferred embodiment, the middle part of the tubes is inserted into the illumination chamber, which is made of mirrors to reflect the light in all directions. In some embodiments, light source generates light of different wavelengths.

According to an embodiment of the present invention, a surface functionalized tube with a binding material can be an effective chamber for capturing materials such as disease causing agents. In a preferred embodiment, binding material such as adhesion molecules, for example antibodies or aptamers, are used to target specific pathogens. The chamber and the photosensitizer-antibody conjugates are easily prepared with a specific antibody. In some embodiments, binding materials that target a large group of disease causing agents is used without the need to first identify the disease causing agents. These general purpose molecules are used to coat the chamber (i.e. tube) and conjugate to the photosensitizer. In some embodiments, binding materials such as antibodies or molecules targeting alpha gal, a carbohydrate found in the cell membrane of most organisms, but not in human cells, is used as a target.

According to an embodiment of the present invention, the chamber (i.e. a tube) is coated with binding materials that include pathogen killing agents to directly kill pathogens. For instance, agents that inhibit pathogen cell wall biosyntheses, such as beta-lactam antibiotics, or even stronger agents, are employed and coated on the tube. Given that these agents are not taken directly by the patient, but rather reside on an extracorporeal tube, toxicity is reduced. In some embodiments, the apparatus and method are used to remove pathogens, particles, disease causing organisms, disease causing molecules, toxins, and excess molecules that cause disease. Variations of this invention are used to disinfect areas. In some embodiments, the apparatus and method are used following a screening procedure and determining the cause of illness. In some embodiments, the apparatus is used also for diagnostics. The captured organisms are collected then tagged with die to determine the type of infection.

According to an embodiment of the present invention, the apparatus and method is specialized for capturing a single bacterium, such as MRSA, which is a major problem in hospital infection. In some embodiments, the chamber is used as an enrichment device for target organisms. By circulating fluids (such as complex media patient's blood, other types of fluids, media or broth) through a series of capturing tubes with binding materials (such as specific antibodies (or other targeting molecules)), microorganisms distributed in the entire body in very low concentration can be rapidly concentrated in each tubes without necessity for further isolation steps. This significantly reduces the time required for sepsis diagnosis or food borne pathogen diagnosis. In a preferred embodiment, this invention may be used to clear the blood of gram negative and positive bacteria, parasites, fungi, other unwanted microorganisms, harmful microorganisms, particles, microparticles, nanoparticles, other disease causing agents and molecules as described previously. This invention may be used during surgery, post-surgery, pre-surgery, therapy. This invention may be used in the field, in a hospital, or in a patient's home.

According to an embodiment of the present invention, the blood flow rates are 0.5 ml/min. In some embodiments, blood flow rates are adjusted to any desired value between 0.01 and 3000 ml/min. In a preferred embodiment, the blood is returned to the patient. It is noted that smaller internal diameter tubes have smaller flow rates. Pursuant to this disclosure, larger internal diameter tubes have a diameter of 10 mm and smaller internal diameter tubes have internal diameters of 1 mm. According to an embodiment of the present invention, the flow rate through the first tube connected to the patient is 100 ml/min, the second tubes (ranging in number from 1 to 400 tubes) have a flow rate of 0.5 ml/min and are smaller in diameter, for example 1 mm in diameter.

According to an embodiment of the present invention, complex media flows through a tube of diameter 1 mm at a specific flow rate (for example a flow rate of a fixed value between 0.5 and 50 mL/min such as 1 mL/min or 2 mL/min). In some embodiments, a multi-connector junction it is connected to a multiport manifold with a device which is made of 100 tubes of 1 mm diameter each about 1-meter long. The fluid now flows through the 100 tubes at 0.5 mL/min flow. These tubes may be pre-coated with binding material. The binding material may be an adhesion molecule or a killing agent. In some embodiments, the 100 tubes are connected via another connector to yet another 100 tubes (i.e. a third group of tubes) of the same size and length with additional binding material. In some embodiments, additional groups of 100 tubes are connected. Following the process, the last group of 100 tubes is connected to a connector manifold that contains only one tube on the other side. The one tube is connected to a syringe or a container with the fluids or directly to a patient. The number of tubes, their dimensions, and the flow rates are offered as examples.

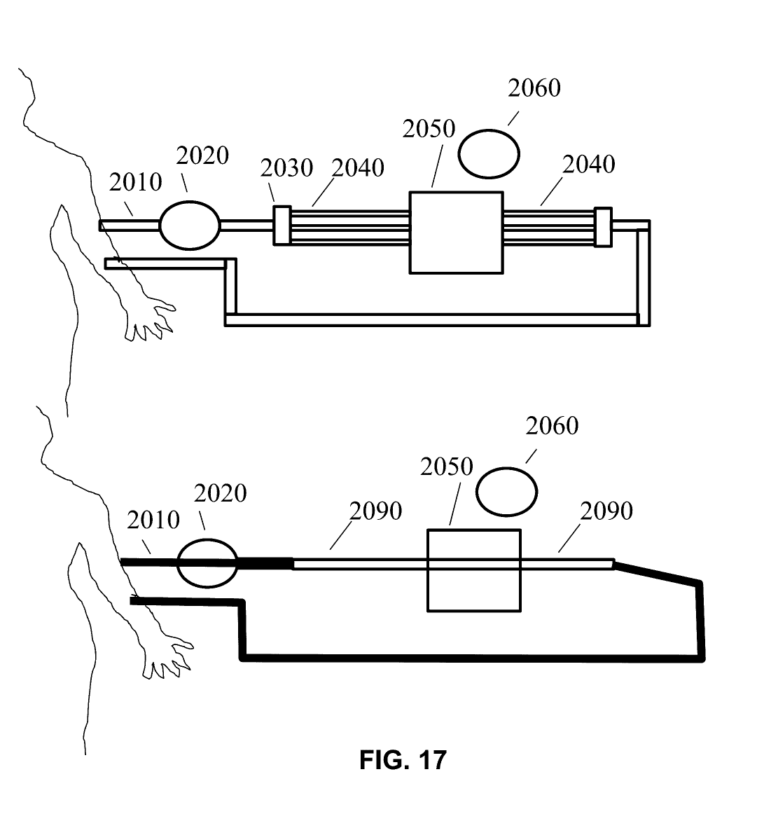

In FIG. 17 (not in scale, conceptual illustration) a large diameter tube (2010) carries a fluid sample, in accordance with an embodiment of the present invention. In a preferred embodiment, the fluid sample is pumped by a pump (2020). A tube splitter (2030) connects the first tube to many tubes (2040) (thereby reducing the flow rate) and those tubes may be coated with pathogen capturing material. In some embodiments, the chamber is heated to a temperature conducive to pathogen growth. In some embodiments, only the coated section (or part) with binding material of the chamber is heated. In some embodiments, a hot plate is to heat the chamber, while in other embodiments the camber is placed inside an temperature controlled incubator.

According to an embodiment of the present invention, a tube (2010) carries the fluid sample. In a preferred embodiment, the fluid sample is pumped by a pump (2020). In the preferred embodiment, a tube connector connects the first chamber to another chamber (2090) coated with binding material. In some embodiments, the chamber is coated with the binding material.

Turning now to FIG. 18, a chamber (2110) with an inlet (2120) and an outlet (2130) for tube connection, in accordance with an embodiment of the present invention. In some embodiments, the chamber's thickness is less than 1 mm, with a preferred thickness of 0.5 mm. In another embodiment, the thickness of the chamber is 1 mm. In yet another embodiment, the thickness of the chamber is 0.1 mm. In some embodiments, the chamber§is transparent to light.

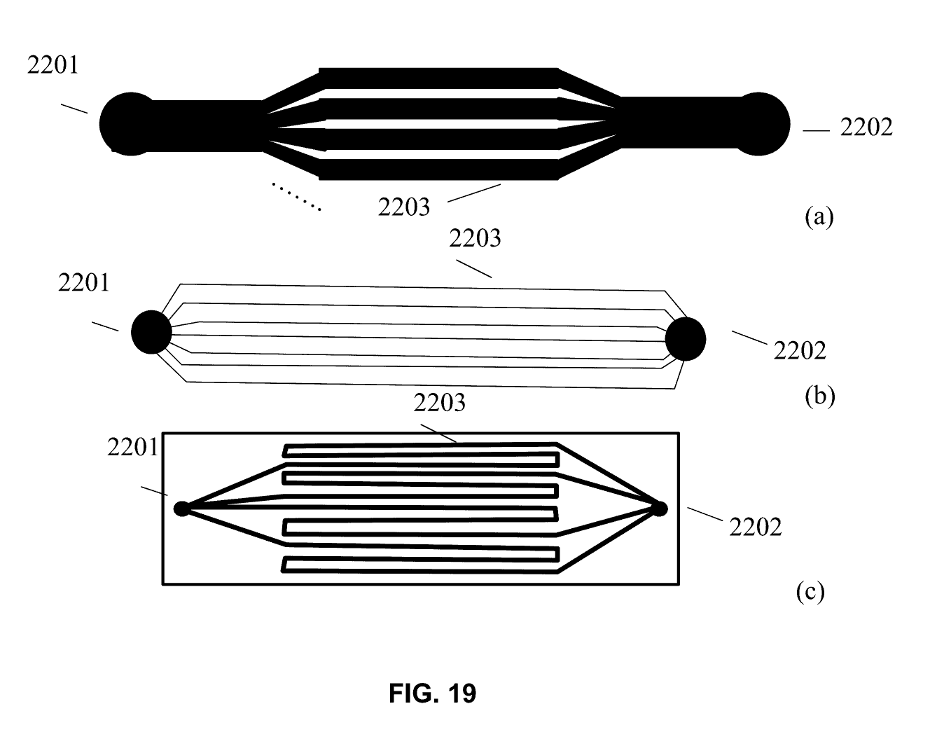

Turning now FIG. 19, chamber configured with an inlet (2201) and outlet (2202), in accordance with an embodiment of the present invention. In a preferred embodiment, the inlet and outlet are designed to fit and attach to a tube having multiple channels with the same cross sectional area (2203), for example each channel is 0.5 mm or 1 mm thick, 1 mm wide, and 1 meter long. In some embodiments, a chamber is a plate with an inlet and an outlet and multiple channels. As shown in FIG. 19 (c), the channels of the chamber may have meandering construction. In some embodiments, the plate is 300 mm×300 mm, while in another it is 480 mm×480 mm. In some embodiments the channels are transparent to light and rest on a reflective surface such as a thin metal film like gold or silver. In some embodiments, the substrate is a silicon substrate or glass substrate with a reflective layer, such as gold or silver, for reflection of light on top and the inlet, outlet and channels resting on top of the reflective layer.

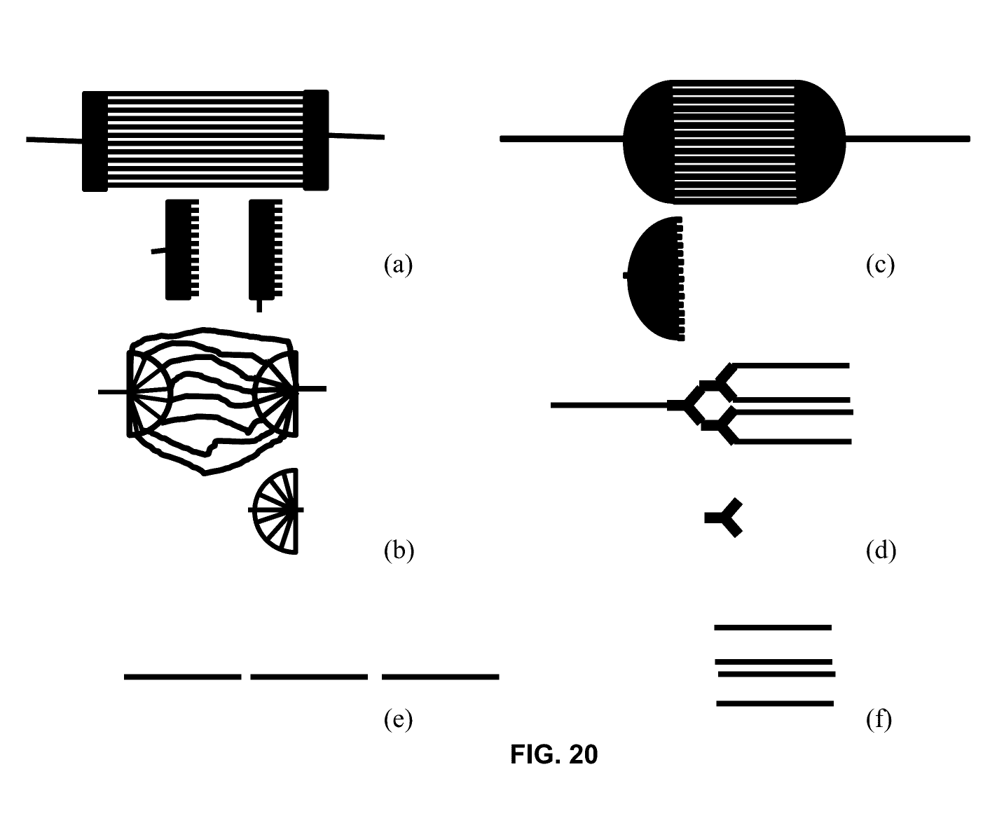

Turning now to FIG. 20, various tube connectors are shown as examples, in accordance with an embodiment of the present invention. In a preferred embodiment, the device comprises a tube connector connecting the first tube to multiple tubes. In some embodiments, the tube is a medical transparent tube. Additionally, a medical extension tube with multi connector can be used. In some embodiments, a tube splitter or connector or manifold is used. In some embodiments, shown in FIG. 20 (a)-(c) the splitter or manifold connects one tube to multiple tubes. In some embodiments, the splitter splits the first tube into two then the resulting two tubes are split into four using another splitter. As shown in FIGS. 20 (b) and (c), the tube manifold may be semicircular. As shown in FIG. 20 (e), the tubes may be connected in series, with each tube having a different binding material. As shown in FIG. 20 (f), the tubes may be connected in parallel, with each tube having a different binding material. In some embodiments, each tube is analyzed to determine the type/kind of disease causing agent. For instance, a die is used to indicate the presence of a disease causing agent like a bacterium. If the bacterium is present, then a florescent color would be present.

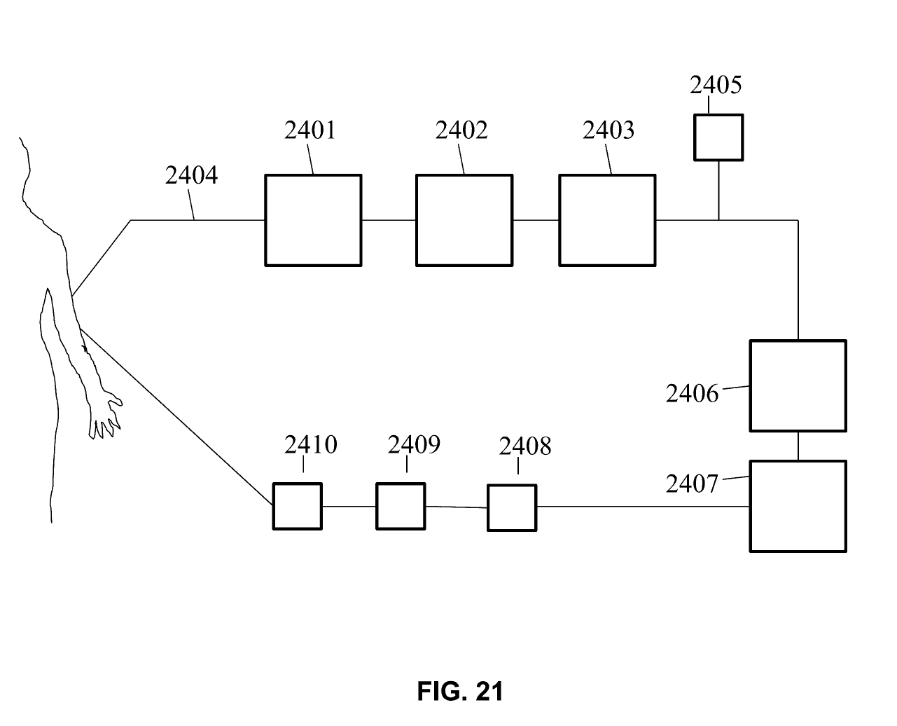

FIG. 21 illustrates some embodiments of the apparatus as part of a dialysis machine. In a preferred embodiment, fluid sample flows through a tube (2404) from a source (patient or container) to an arterial pressure monitor (2401), then into a pump (2402). In some embodiments, a pump with anticoagulant such as heparin (2403) is connected to ensure there is no coagulation and to prevent clotting, a saline solution is included (2405). The tube then connects to a dialyser (2406). At the top of the dialyser, fresh dialysate is pumped in and at the bottom used dialysate is removed (not shown), with the dialyser being used to remove toxins, including microbial toxins which are toxins produced by micro-organisms. The blood then flows through a tube into said apparatus (2407). In some embodiments, the device (2407) is a tube coated with binding material for capturing pathogens (cancer cells, bacteria, fungi, viruses, etc.) or several tubes that are connected to each with a different binding material. After a certain predetermined time, the tube or tubes are removed and the captured pathogens are analyzed. Analysis includes any of the following techniques: direct visualization or detection inside the tube (described below), removal of pathogens (for example using detachment buffer or trypsin), lysis of the pathogens from the inside of the tube and performing other types of analysis such as gene detection, PCR, ELISA etc. In some embodiments, the tube is exposed to light of specific wavelength as the ones described earlier. A filter (2408) removes items larger than several microns such as larger than 40-micron diameter objects. A venous pressure monitor (2409), as well as an air trap and air detector (2410) may also be incorporated into the overall apparatus. Finally, the blood is recirculated back to the patient. In some embodiments, the apparatus is part of a dialysis machine.

Turning now to FIG. 22, a schematic of the apparatus (also called pre-concentration system), in accordance with an embodiment of the present invention. In a preferred embodiment the fluid sample (such as any of the following complex media, water, blood, other fluid, urine, sputum, broth, culture media, body fluids, sweat) resides inside a container (2510) containing target material such as target pathogens (2550), other particles (for example natural flora, blood components) (2560), and other particles (for example: food particle, blood cells etc.) (2570) that are continuously pumped through the chamber (for example a tube) (2530) coated with binding material (for example capturing antibody or aptamers) (2540) by a pump (such as a peristaltic pump) (2520). In its simplest form, the apparatus includes a tube with binding material and a pump. In some embodiments, instead of a container, the apparatus is connected directly to a patient (FIG. 1). In some embodiments, during the flow through the chamber (i.e. the tube) the pathogens are captured by binding material (example antibodies or aptamers, etc.) coated inside the chamber. In this embodiment, the capture and subsequent continuous flow of fluid sample (examples of fluids include sample matrix, blood, media, food sample, water, liquids) promotes the concentration the pathogens within the chamber as pathogens are captured and divide inside the chamber. This method becomes part of the initial incubation and enables extraction of pathogens from the entire volume of fluid sample. In some embodiments, the quantity of pathogen inside the chamber reaches sufficient levels for detection in an early stage of pre-enrichment (starting with 1 single pathogen (such as a bacterium), to 10³ bacteria are reached on less than 5 hours (assuming a 20-minute doubling time and unstressed/uninjured parent cells)). In this embodiment, there is no need for dilution or aliquoting. Furthermore, in some embodiments, multiple chambers (i.e. multiple tubes serially connected) with binding materials (such as antibodies) are used with a single fluid sample enabling pathogen identification and/or multiple pathogen detection simultaneously. Thus the apparatus is a diagnostic tool, as well as a pre-concentration tool reducing time, cost, and effort. A fluid sample contains one of the following: food sample in culture media, urine, sample with pathogens such as bacteria, blood, blood from septic patient, sputum, swab with pathogens from human or environment, fluids, water. The sample resides in a container or flask or other holding device or is directly extracted from a human or an animal and reinserted after flow through the apparatus.

FIG. 23 describes the advantage of pre-concentration method over conventional culturing method, in accordance with an embodiment of the present invention. The conventional method (a) requires at least 18-24 hours of pre-enrichment for detection of pathogen (2550) from complex media (2510). On the other hand, the pre-concentration method (b) that uses immunocapturing by flow through a chamber (2530) enables detectable quantity of pathogens at a significantly earlier time than the conventional method. Also, by combining multiple chambers (i.e. multiple tubes) (c) (2530) with various binding materials (2540) for different pathogens, multiple pathogen detection and identification is achieved. In a preferred embodiment, the pathogens are attached to the chambers and then analyzed to identify them.

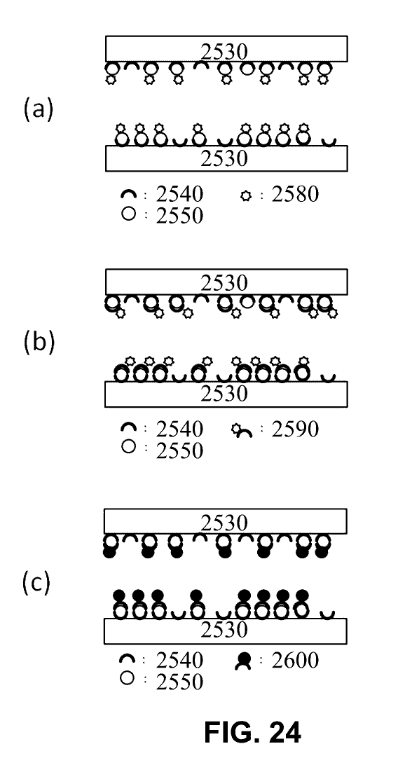

FIG. 24 describes the reporting method for capture of target pathogen, in accordance with an embodiment of the present invention. In a preferred embodiment, once the pathogens are captured, they can be stained by optical tags (fluorescent dyes or chromogenic dyes) (2580), optical tag labeled antibody (2590), or magnetically labeled antibody (2600). With these tags, a chamber with positive capture is visualized by either one or a combination of the following: color, fluorescence, using eyes, microscope, black light illumination. In some embodiments latex agglutination methods are used with latex immunoagglutination kits. The above techniques are used following capturing. In some embodiments, indicator analytes for pathogens (such as intercellular enzymes or environmental chemicals consumed by pathogens) are used. In some embodiments, probes that are composed of gold nanoparticles with adhesion molecules (such as antibodies) and “biotin to link streptavidin-HRP, which reacts with tetramethyl benzidine (TMB) for signal amplification for visual detection” (Ren, Wen, et al. Chemical Communications 52.27 (2016): 4930-4933. DOI: 10.1039/c5cc10240e; Cho, I. & Irudayaraj, J. Anal Bioanal Chem (2013) 405: 3313. doi:10.1007/s00216-013-6742-3) or other methods to amplify the signal are used. In some embodiments, the chambers are washed, then the reporting methods are used. In some embodiments, captured materials are identified inside the chamber. In some embodiments, the captured material is detached (released, removed) from the chamber and then identified. In some embodiments, detection is performed by coating microbeads (for example latex beads) with pathogen-specific antigens or antibodies. After the capturing material is captured, the chamber is washed with saline and the coated microbeads particles are inserted in the chamber. Agglutination of the beads is considered a positive result for the presence of the particular capturing agent (example pathogen). Using these techniques, detection of pathogens, viruses, bacteria, fungi, autoantibodies, autoimmune diseases and other biomolecules, peptides, and antibodies is enabled. When the captured material is detached, a detachment agent is used, such agents include Pluriselect's detachment buffer, Trypsin, other agents used for detachment. In some embodiments, the pathogens are lysed inside the chamber using lysis buffer and the content is then amplified using PCR techniques. Alternatively, a phage is used for diagnosis. A bacteriophage may be used either after or during the capturing process. The chamber captures the pathogens. In some embodiments, the chambers are coated with binding material that captures the phage reporter (pathogen byproduct). Thus, the chamber concentrated the phage reporter protein inside a small area allowing it to be visualized during the pre-enrichment process. Thus, the detection mechanism is much faster.

According to an embodiment of the present invention, detection is achieved using bacteriophages (phages) as bacterial detectors. Using phage-based diagnostics (including reporter phage, phage-amplification, phage-labeling) detection is enabled. In some embodiments, phage amplification assays are used. For instance, Luciferase Reporter Bacteriophage may be used for detection. Reporter phage technology is used while the fluid sample circulates through the apparatus to directly visualize the detectable molecules in real time. In some embodiments, after sufficient target material has been captured by the binding material on the inner surface of the chamber, the apparatus is disconnected from the container and bacteriophages are inserted in the chamber and allowed to interact with the pathogens and produce detectable molecules. Bacteriophages employ the bacteria and microorganisms to produce detectable molecules including molecules with colorimetric, luminescence, fluorescence signals by genetically engineering phages. In some embodiments, the binding material binds to the bacteriophages' detectable molecules. In some embodiments, the binding material binds to the pathogen.

In some embodiments, the apparatus is placed inside an incubator. In some embodiments, the apparatus is placed on top of a heated plate. In some embodiments, the binding material preparation (described in FIG. 10, 11, 13, 16, and respective paragraphs) of the chamber is entirely automated and performed by an automated apparatus. In some embodiments, the same apparatus is used for preparation (in situ) as well as capturing of the capturing material. The apparatus and method described in this disclosure are used for a number of applications including: STD point of care, point-of-care analytical method, point-of-care-testing, pancreatic cancer diagnosis, cancer diagnosis and prognosis, other biomolecules indicative of disease, bacteria, cancer cells, food borne pathogen detection, and other applications as described in herein.

The apparatus disclosed can significantly accelerate pathogen detection by concentrating pathogens within a few hours at above detection limits (LOD). In food pathogen detection for example, the standard food pathogen detection procedure entails inserting 25 grams of food sample into media so that the total volume is 250 mL and allowing the bacteria to grow for 24 hours. The regulations require zero tolerance (i.e. 1 bacterium per sample (25 gr)), which means that even if 1 bacterium is present it has to be detected using detection techniques. A typical bacterium, for example e-coli, doubles every 20 minutes. To reach 1,000 it takes about 3.3 hours and in 5 hours it may reach over 32,700. However, in a 250 ml volume the number of bacteria per mL would be significantly lower. In the previous example, the number of bacteria would be about 130 in 1 mL. Methods that have a limit of detection (LOD) like PCR (1000 CFU/mL) and ELISA (10,000 CFU/mL) are not able to detect these small quantities in 4-5 hours.

The principle of the invention is straightforward: by continuously flowing the sample solution through the adhesion molecule (such as protein) coated tubes, the targeted materials (like pathogens) are selectively captured (and grow inside tube), the original sample has increasingly less pathogens as these stick to the walls of the tube (and start multiplying inside the tube) with 1 mL volume. At starting concentrations as low as one bacterium per sample, 1000-10000 bacteria/ml can be reached in a 3-4 hours at a typical bacterial growth rate. The bacteria inside the tube are then released or lysed enabling the detectable concentration within a few hours by laboratory techniques like PCR and ELISA. Common food pathogens, including, but not limited to, Salmonella, E. Coli. O157:H7, and Listeria may be captured with this technique. Multiple tubes with adhesion molecule (such as protein, antibodies) corresponding to different pathogens can be connected in order to inspect for more than 1 pathogen per sample. This invention can be uniquely used as a diagnostic tool and a pre-concentration tool reducing time, cost, and effort. Also, this approach allows multiple pathogen detection simultaneously in single sample batch mode. This, in turn, reduces work flow by not requiring a separate sample for each pathogen detection, thereby reducing the number of tests, manpower, time, and resources to determine the presence of a pathogen.

To summarize this disclosure: An apparatus for capturing target material from fluid samples. The apparatus comprises a tube for flowing a fluid sample in a chamber, the tube connected to the chamber, a pump connected to the tube establishing continuous constant flow in the chamber, wherein the chamber comprises an inlet from which fluid sample flows in to the chamber, and an outlet, a binding material on the inner part of the chamber to capture target material, a tube connected to the outlet of the chamber which returns the fluid sample to the source. In some embodiments, the chamber is comprised of a plurality of chambers connected in series via a connector. In some embodiments, each of the chambers is coated with a different binding material targeting different target material. In some embodiments, the binding material is one or more binding materials selected from a group of binding material comprising antibodies, polymers, synthetic polymers, adhesion molecules, aptamers, peptides, adhesion materials. In some embodiments, the chamber is one or more chambers selected from a group of chambers comprising a tube, a parallelepiped, a rectangular parallelepiped, or a cylinder. In some embodiments, the chamber is a PDMS plastic tube with inner diameter smaller than 1.5 mm. In some embodiments, the captured target material is identified inside the chamber using detection techniques. In some embodiments, the captured target material is removed from the chamber and identified outside of the chamber using detection techniques. In some embodiments, the captured target material is lysed inside the chamber and identified using PCR outside the chamber.

This method is adaptable to any adhesion molecule. While the invention has been described with reference to the embodiments above, it will be readily understood by those skilled in the art that equivalents may be substituted for the various elements and modifications made without departing from the spirit and scope of the invention. It is to be understood that all technical and scientific terms used in the present invention have the same meaning as commonly understood by one of ordinary skill in the art to which this invention belongs. Accordingly, the drawings and descriptions are to be regarded as illustrative in nature and not restrictive.

The invention claimed is:

1. An apparatus for capturing target material from a fluid sample, said apparatus comprising:
one or more entrapment chambers each of which comprises an inlet, an outlet, and one or more chamber walls that define a target material entrapment area;
a binding material that captures a target material, wherein said binding material is coated on an inner portion of said chamber walls to be in fluid contact with said target material entrapment area;
an inlet tube that connects between a fluid source and said inlet of one of said entrapment chambers to flow said fluid sample into said entrapment chambers;
an outlet tube that connects between said outlet of one of said entrapment chambers and said fluid source to return said fluid sample to said fluid source; and
a pump connected to said inlet tube that generates a continuous flow of said fluid sample through said target material entrapment area of said entrapment chambers.

2. The apparatus of claim 1, wherein a first of said entrapment chambers is connected to a second of said entrapment chambers in series via a connector.

3. The apparatus of claim 1, wherein flow rate of said fluid sample through said inlet of said entrapment chamber is less than 1.5 mL/min.

4. The apparatus of claim 2, wherein said first entrapment chamber is coated with a different binding material than said second entrapment chamber thereby enabling said apparatus to simultaneously capture different target materials.

5. The apparatus of claim 1, wherein said binding material is one or more binding materials selected from a group of binding material consisting of antibodies, polymers, synthetic polymers, adhesion molecules, aptamers, peptides, proteins, and adhesion materials.

6. The apparatus of claim 1, wherein any of said entrapment chambers is one or more chambers selected from a group of chambers consisting of a tube, parallelepiped, rectangular parallelepiped, and a cylinder.

7. The apparatus of claim 1, wherein any of said entrapment chambers is a plastic tube with inner diameter smaller than 1.5 mm.

8. The apparatus of claim 1, wherein said target material is identified inside one of said entrapment chambers using detection techniques.

9. The apparatus of claim 1, wherein said target material is removed from one of said entrapment chambers and identified outside of said entrapment chamber using detection techniques.

10. The apparatus of claim 1, wherein said target material is lysed from inside of one of said entrapment chambers and identified using polymerase chain reaction outside of said entrapment chamber.
